(19) United States
(12) Patent Application Publication
(10) Pub. No.: US 2010/0162666 A1
(43) Pub. Date: Jul. 1, 2010

(54) PACKAGING MATERIAL HAVING BIREFRINGENT PATTERN

(75) Inventors: Kouki TAKAHASHI, Minami-ashigara-shi (JP); Hideki KANEIWA, Minami-ashigara-shi (JP); Satomi SUZUKI, Minami-ashigara-shi (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/647,630

(22) Filed: Dec. 28, 2009

(30) Foreign Application Priority Data
Dec. 26, 2008 (JP) 2008-334406

(51) Int. Cl. B65B 11/02; B32B 7/02; B44F 1/10; B29C 71/02

(52) U.S. Cl. 53/461; 428/212; 428/29; 264/234

(57) ABSTRACT

A packaging material, having at least one optically anisotropic layer which is made from substantially the same layer-forming composition and includes two or more regions different in birefringence property.

### FIELD OF THE INVENTION

The present invention relates to a packaging material that is applicable for authentic product identification and the like utilizing optical anisotropy.

### BACKGROUND OF THE INVENTION

Known examples of means for identifying means to distinguish authentic products from fakes or frauds in commercial product distribution, include attachment of security materials (see for example JP-A-9-77174 (“JP-A” means unexamined published Japanese patent application)), printing or processing of security marks (see for example JP-T-2003-535997 (“JP-T” means published Japanese translation of PCT application)) and containers to which security materials are attached (see for example JP-A-2005-289446).

In the techniques mentioned above, however, authentic product identifying means is apparent so that counterfeiting of the authentic product identifying means can be easily attempted and in some cases, design of the product can be degraded due to attachment or printing of security materials onto the object products or packing containers. In addition, it is also difficult to prepare containers themselves to which security materials are attached for every product size in the case of small quantity, a wide variety of products. Under the circumstances, there has been a demand for development of new authentic product identifying means capable of solving the problems.

### SUMMARY OF THE INVENTION

The present invention resides in a packaging material, comprising at least one optically anisotropic layer which is made from substantially the same layer-forming composition and includes two or more regions different to each other in birefringence property.

Further, the present invention resides in a method for producing the packaging material, comprising: forming a layer of a composition containing a liquid crystalline compound having a reactive group; applying different reaction conditions to a plurality of regions in the layer; and then performing heating to make the unreacted region optically isotropic and to deactivate the reactive group.

Other and further features and advantages of the invention will appear more fully from the following description, appropriately referring to the accompanying drawings.

### BRIEF DESCRIPTION OF THE DRAWINGS

FIG. 1 is a schematic cross-sectional view showing an embodiment of a packaging material according to the invention.

FIGS. 2 (a) and 2 (b) each are a diagram showing an example of a birefringent pattern. FIG. 2 (a) is an explanatory diagram of an example where patterning is performed with respect to retardation. FIG. 2 (b) is an explanatory diagram of an example where patterning is performed with respect to optical axis direction.

FIG. 3 is a view showing the shape of the photomask V used in Examples.

FIG. 4 is an enlarged view showing the pattern of the patterned birefringent product produced in Examples when it was viewed through a polarizing plate.

### DETAILED DESCRIPTION OF THE INVENTION

As a result of investigations to solve the above problems, the inventors have made the invention based on the finding that when packaging materials are provided with ordinarily invisible authentic product identifying means, more easily handleable and less findable authentic product identifying means can be provided.

According to the present invention, there is provided the following means:

[1] A packaging material, comprising at least one optically anisotropic layer which is made from substantially the same layer-forming composition and includes two or more regions different in birefringence property;
[2] The packaging material according to the above item [1], wherein the optically anisotropic layer is formed by using a liquid crystalline compound having a reactive group;
[3] The packaging material according to the above item [2], wherein the liquid crystalline compound in the optically anisotropic layer is oriented in a substantially constant direction;
[4] The packaging material according to any one of the above items [1] to [3], wherein a substrate having the optically anisotropic layer has a retardation of 2,000 nm or less;
[5] The packaging material according to any one of the above items [1] to [4], wherein it is transparent;
[6] The packaging material according to any one of the above items [1] to [4], comprising a reflective layer;
[7] The packaging material according to any one of the above items [1] to [6], wherein a latent image is visible through a polarizing plate;
[8] A method for producing the packaging material according to any one of the above items [1] to [7], comprising: forming a layer of a composition containing a liquid crystalline compound having a reactive group; applying different reaction conditions to a plurality of regions in the layer; and then performing heating to make the unreacted region optically isotropic and to deactivate the reactive group; and
[9] A packaging method, comprising wrapping an object having a reflective surface with the packaging material according to any one of the above items [1] to [7].

As used herein, the term “a substrate having the optically anisotropic layer” refers to a supporting material or any other substrate (part) not having undergone a retardation-imparting process.

[10] A method of packaging an object in the packaging material according to the above item [1].

Some examples of preferable embodiments of the present invention are described below in detail.

In the present specification, “to” for a numerical range denotes a range including numerical values described before and after it as a minimum value and a maximum value.

Herein, in the present specification, the term “retardation” or “Re” means an in-plane retardation, and the term “Re(λ)” indicates an in-plane retardation at wavelength λ (nm). The in-plane retardation (Re(λ)) can be measured by making light of wavelength λ nm incident in the direction of the normal of the film, in KOBRA 21ADH or WR (each trade name, manufactured by Oji Scientific Instruments). In the present specification, retardation or R^{e} means one measured at wavelength λ 545±5 nm or 590±5 nm.

In the present specification, the term “birefringent pattern” means a pattern having two or more regions different in birefringence property. The product having a birefringent pattern may be any sheet-shaped product or any product having a patterned portion including a plurality of regions different in birefringence property. The product having a birefringent pattern generally includes a patterned optically anisotropic layer, specifically a layer including a plurality of regions different in birefringence property. The regions different in birefringence property may be different from one another in retardation and/or optical axis direction. In the present specification, the term “optical axis” means “slow axis” or “transmission axis.” In the present specification, the feature “having two or more regions different from one another in retardation and/or optical axis direction” is also expressed by the phrase “having a pattern of retardations and/or optical axis directions” or “the retardation and/or the optical axis direction is patterned.” The birefringent pattern more preferably has three or more regions different in birefringence property. Individual regions having the same birefringence property may have a continuous shape or discrete shapes. The patterned optically anisotropic layer may be a single layer or a laminate of layers, as long as its function for the packaging material is not inhibited. The product having a birefringent pattern may generally have a plane shape (the shape of a film or sheet). Since the regions are recognized when the birefringent pattern is observed in a normal direction of the plane, the regions may be regions divided by a plane parallel to the normal direction of the plane.

In the present specification, the term “latent image” means an image that is invisible under normal conditions without a polarizer or the like but is visualized through a polarizer, more preferably visualized by using a polarizer and a device for authenticating the birefringent pattern having the patterned optically anisotropic layer. The visualized image preferably includes regions showing two colors other than black, while it may have any feature as long as it includes two or more regions showing different colors. It is also preferred that there are three or more regions showing different colors. Three or more regions different in reflection or transmission spectrum may be provided so that three or more regions showing different colors can be provided. Specifically, there may be three or more regions that show different polarizations after polarized light comes in and passes through each optically anisotropic layer, or immediately before it comes in a polarizing plate on the output side. Therefore, each optically anisotropic layer are not required to have three or more different retardations. For example, a case where a laminate of two optically anisotropic layers having the same optical axis is considered as follows. Assuming that four regions A, B, C, and D of a first optically anisotropic layer have retardations of 0 nm, 0 nm, 100 nm, and 100 nm, respectively and four regions of a second optically anisotropic layer have retardations of 0 nm, 200 nm, 0 nm, and 200 nm, respectively, the total retardations of the respective regions are 0 nm, 200 nm, 100 nm, and 300 nm, so that four different colors can be expressed. The visualized image preferably shows a letter or a picture in view of authentication capability.

The colors described above may also include colors at wavelengths outside the visible light region, and such invisible wavelengths may be identified through an imaging device or the like.

In the present specification, the term “identification” includes the meaning of “determination,” “authentication,” “confirmation of the presence or absence,” or “determining real or fake one.” The birefringent pattern may be used in a packaging material for a variety of commercial products such as pharmaceuticals, household electrical appliances, and garments. Products may be identified based on the birefringent pattern with the aid of the system according to the invention, which is useful for so-called brand protection. The birefringent pattern may have the patterned optically anisotropic layer on a reflective support, on a transparent support or in a transparent support.

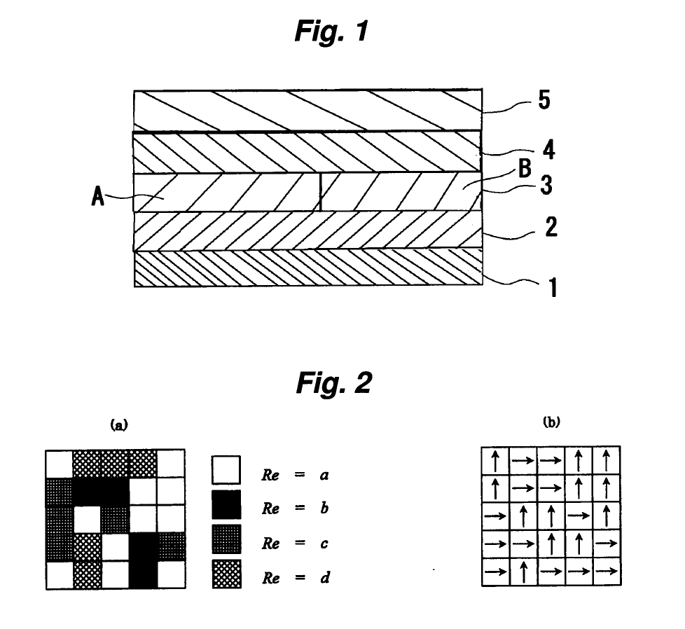

FIG. 1 is a schematic cross-sectional view showing a packaging material according to one embodiment of the invention. The packaging material shown in FIG. 1 is produced by transferring a birefringent pattern and includes a support 1, an adhesive layer 2 and an optically anisotropic layer 3 placed on the support 1 with the adhesive layer 2 interposed therebetween, wherein the adhesive layer 2 and the optically anisotropic layer 3 are transferred onto the support 1. The optically anisotropic layer 3 has regions A and B, which differ from each other in birefringence property. An alignment layer 4 is laminated on the optically anisotropic layer 3, and a mechanical characteristic control layer 5 is formed as the uppermost layer. The birefringent pattern, the optically anisotropic layer and each layer optionally provided are described in detail below.

For example, the birefringent pattern is formed in a product including a patterned optically anisotropic layer having a pattern of in-plane retardations and/or in-plane optical axis directions. An example of the birefringent pattern is shown in FIG. 2.

FIG. 2(a) is an explanatory diagram of an example in which patterning is performed with respect to retardation. In the example shown in FIG. 2(a), retardations of a nm, b nm, c nm, and d nm are different from one another. FIG. 2(b) is an explanatory diagram of an example in which patterning is performed with respect to optical axis direction. In FIG. 2(b), the arrows each indicate an optical axis direction.

The optically anisotropic layer having a pattern of in-plane optical axis directions may be obtained, for example, by the method described in JP-T-2001-525080.

The optically anisotropic layer having a pattern of in-plane retardations may be produced, for example, by the method described in detail below.

### [Birefringent Pattern Member]

### (Optically Anisotropic Layer)

In the invention, the optically anisotropic layer is made from substantially the same layer-forming composition. As used herein, the term “the same layer-forming composition” means that strictly speaking, the raw materials differ in molecular electronic state or birefringence property, but they are materially identical.

In the invention, the packaging material having a birefringent pattern includes at least one optically anisotropic layer. The optically anisotropic layer is the layer having at least one incident direction, of which retardation (Re) is not substantively zero when a phase difference is measured. In other words, the optically anisotropic layer is the layer having non-isotropic optical characteristic.

The optically anisotropic layer in the birefringent pattern member (a product having the pattern) contains a polymer. By containing the polymer, the birefringence pattern builder can meet various requirements such as birefringence property, transparency, solvent-resistance, toughness, and flexibility. The polymer in the optically anisotropic layer prior to patterning is preferred to have an unreacted reactive group. It is because, although light exposure leads to crosslinking of the polymer chain in reaction of unreacted reactive groups, the degree of crosslinking of the polymer chain varies by exposure under different exposure conditions, consequently leading to changes in retardation, thus making it easier to prepare such a patterned birefringent product.

The optically anisotropic layer may be solid at 20° C., preferably at 30° C., and more preferably at 40° C., because an optically anisotropic layer which is solid at 20° C. can readily be applied with another functional layer, or transferred or sticked to a support.

In order to be applied with another functional layer, the optically anisotropic layer is preferred to have solvent-resistance. In the specification, “to have solvent-resistance” means that the retardation of the layer after soaked in the subject solvent for two minutes is in the range of 30 to 170%, more preferably 50 to 150%, most preferably 80 to 120%, with respect to the retardation of the layer before the soaking. As the subject solvent, examples include water, methanol, ethanol, isopropanol, acetone, methylethylketone, cyclohexanone, propyleneglycolmonomethyletheracetate, N-methylpyrrolidone, hexane, chloroform, and ethyl acetate. Among them, acetone, methylethylketone, cyclohexanone, propyleneglycolmonomethyletheracetate, and N-methylpyrrolidone are preferable; and methylethylketone, cyclohexanone, and propyleneglycolmonomethyletheracetate, and a mixture thereof are most preferable.

The retardation of the optically anisotropic layer at 20° C. may be 5 nm or more, preferably 10 nm or more and 2,000 nm or less, and most preferably 20 nm or more and 1,000 nm or less. If the retardation is 5 nm or less, it may be difficult to form the birefringent pattern, or the latent image may have reduced clarity. When the retardation is more than 2,000 nm, error becomes larger and it may become difficult to achieve practically needed accuracy.

The retardation value of the optically anisotropic layer may be controlled taking into account the formation of the latent image in the packaging material or the retardation of any other layer that forms the packaging material.

Although the production method of the optically anisotropic layer is not particularly limited, methods shown below for example may be used.

a) A method of producing an optically anisotropic layer by coating and drying a solution containing a liquid crystalline compound having at least one reactive group to form a liquid crystalline phase, and then by polymerizing and fixing the compound by applying heat or irradiating ionizing radiation to the liquid crystalline phase.

b) A method of stretching a layer obtained by polymerizing and fixing a monomer having at least two or more reactive groups.

c) A method of introducing a reactive group into a layer made of a polymer by a coupling agent to subsequently stretch the layer.

d) A method of stretching a layer made of a polymer to subsequently introduce a reactive group into the layer by a coupling agent.

Further, as explained below, the optically anisotropic layer according to the present invention may be formed by transfer.

The thickness of the optically anisotropic layer is preferably 0.1 to 20 μm, and more preferably 0.5 to 10 μm.

[symbol]

((Optically Anisotropic Layer (Material))

[symbol]

### (Optically Anisotropic Layer Formed by Polymerizing and Fixing Composition Comprising Liquid Crystalline Compound)

The production method of the optically anisotropic layer is explained below, wherein coating with a solution comprising a liquid crystalline compound having at least one reactive group is conducted and the solution is dried to thereby form a liquid crystalline phase, and then the liquid crystalline phase is polymerized and fixed by applying heat or irradiating ionizing radiation. As compared with the method described later for producing the optically anisotropic layer by stretching a polymer, this method makes possible the production of the optically anisotropic layer with a small thickness and the same retardation or makes easy sophisticated pattern control.

### (Liquid-Crystalline Compound)

The liquid-crystalline compounds can generally be classified by molecular geometry into rod-like one and discotic one. Each category further includes low-molecular type and high-molecular type. The high-molecular type generally refers to that having a degree of polymerization of 100 or above (“Kobunshi Butsuri-Soten'i Dainamikusu (Polymer Physics-Phase Transition Dynamics), by Masao Doi, p. 2, published by Iwanami Shoten, Publishers, 1992). Either type of the liquid-crystalline molecule may be used in the present invention, wherein it is preferable to use a rod-like liquid-crystalline compound or a discotic liquid-crystalline compound. A mixture of two or more kinds of rod-like liquid-crystalline compounds, a mixture of two or more kinds of discotic liquid-crystalline compounds, or a mixture of a rod-like liquid-crystalline compound and a discotic liquid-crystalline compound may also be used. It is more preferable that the optically anisotropic layer is formed using a rod-like liquid-crystalline compound having a reactive group or a discotic liquid-crystalline compound having a reactive group, because such a compound can reduce temperature- or moisture-dependent changes; and it is still further preferable that the optically anisotropic layer is formed using at least one compound having two or more reactive groups in a single liquid-crystalline molecule.

It is also preferred that liquid-crystalline compound has two or more kinds of reactive groups which have different polymerization condition to each other. In such a case, an optically anisotropic layer comprising a polymer having an unreacted reactive group can be produced by only polymerizing a specific kind of reactive group among plural types of reactive groups by selecting polymerization condition. The polymerization condition to be employed may be wavelength range of the irradiation of ionized radiation for the polymerization and fixing, or mechanism of polymerization. Preferably, the condition may be polymerization initiator, which can control polymerization of compound having a combination of a radically polymerizable group and a cationically polymerizable group. The combination of acrylic group and/or methacrylic group as the radically reactive group and vinyl ether group, oxetane group, and/or epoxy group as the cationically polymerizable group is particularly preferred, because the reactivity can be controlled easily.

In the invention, the final product made from the liquid crystalline compound does not have to exhibit liquid crystalline properties and, for example, may include a polymeric product that has lost the liquid crystalline properties in the process of polymerizing or crosslinking a thermally- or photo-reactive group-containing low-molecular discotic liquid crystalline by a thermal reaction, a photo-reaction or the like.

Examples of the rod-like liquid-crystalline compound include azomethine compounds, azoxy compounds, cyanobiphenyl compounds, cyanophenyl esters, benzoates, cyclohexanecarboxylic acid phenyl esters, cyanophenylcyclohexane compounds, cyano-substituted phenylpyrimidine compounds, alkoxy-substituted phenylpyrimidine compounds, phenyldioxane compounds, tolan compounds, and alkenylcyclohexylbenzonitrile compounds. Not only the low-molecular-weight liquid-crystalline compounds as listed in the above, but also high-molecular-weight liquid-crystalline compounds may also be used. The high-molecular-weight liquid-crystalline compounds are compounds obtained by polymerizing a low-molecular-weight liquid-crystalline compound having a reactive group. Among such low-molecular-weight liquid-crystalline compounds, liquid-crystalline compounds represented by formula (I) are preferred.

Q¹-L¹-A¹-L³-M-L⁴-A²-L²-Q² Formula (I)

In formula (I), Q¹ and Q² each independently represent a reactive group; L¹, L², L³ and L⁴ each independently represent a single bond or a divalent linking group; A¹ and A² each independently represent a spacer group having 2 to 20 carbon atoms; and M represents a mesogen group.

Hereinafter, the rod-shaped liquid crystalline compound having a reactive group represented by Formula (I) will be described in more detail. In formula (I), Q¹ and Q² each independently represent a reactive group. The polymerization reaction of the reactive group is preferably addition polymerization (including ring opening polymerization) or condensation polymerization. In other words, the reactive group is preferably a functional group capable of addition polymerization reaction or condensation polymerization reaction. Examples of reactive groups are shown below. In formula (I), Et represents ethyl group, and Pr represents propyl group.

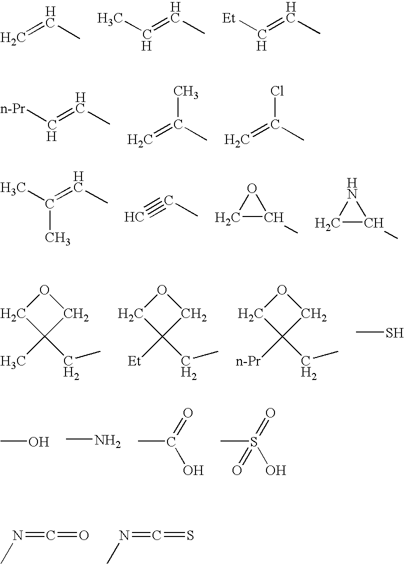

The divalent linking groups represented by L¹, L², L³ and L⁴ are preferably those selected from the group consisting of —O—, —S—, —CO—, —NR²⁰—, —CO—O—, —O—CO—O—, —CH₂—O—, —O—CH₂—, —CO—NR²⁰—, —NR²⁰—CO—, —O—CO—, —O—CO—NR²⁰—, —NR²⁰—CO—O— and —NR²⁰—CO—NR²⁰—. R²⁰ represents an alkyl group having 1 to 7 carbon atoms or a hydrogen atom. In formula (I), Q¹-L¹- and/or Q²-L²- are each preferably a 2-methyl-oxetane group substituted with CH₂═CH—CO—O—, CH₂═C(CH₃)—CO—O—, CH₂═C(Cl)—CO—O—, or —CH₂— as a linking group in position 2, most preferably a 2-methyl-oxetane group substituted with CH₂═CH—CO—O— or —CH₂— as a linking group in position 2.

A¹ and A² each are a spacer group having 2 to 20 carbon atoms; preferably an alkylene, alkenylene or alkynylene group having 2 to 12 carbon atoms; and particularly preferably an alkylene group. The spacer group is more preferably has a chain form, and may contain non-neighboring oxygen atoms or sulfur atoms. The spacer group may have a substituent and may be substituted by a halogen atom (fluorine, chlorine, bromine), a cyano group, a methyl group or an ethyl group.

The mesogen group represented by M may be selected from any known mesogen groups, and is preferably selected from the group represented by the formula (II).

—(—W¹-L⁵)n¹-W²— Formula (II)

In formula (II), W¹ and W² each independently represent a divalent cyclic alkylene or alkenylene group, a divalent arylene group, or a divalent hetero-cyclic group; and L⁵ represents a single bond or a linking group. Examples of the linking group represented by L⁵ include those exemplified as examples of L¹ to L⁴ in the formula (I). In formula (II), n is 1, 2 or 3.

Examples of W¹ and W² include 1,4-cyclohexanediyl, 1,4-phenylene, pyrimidine-2,5-diyl, pyridine-2,5-diyl, 1,3,4-thiazole-2,5-diyl, 1,3,4-oxadiazole-2,5-diyl, naphtalene-2,6-diyl, naphtalene-1,5-diyl, thiophen-2,5-diyl, pyridazine-3,6-diyl. As for 1,4-cyclohexane diyl, either structural isomers having trans-form or cis-form, or any mixture based on an arbitrary compositional ratio may be used in the present invention, where the trans-form is preferable. Each of W¹ and W² may have a substituent, where the examples of the substituent include halogen atoms (fluorine, chlorine, bromine, iodine), cyano group, alkyl groups having 1 to 10 carbon atoms (methyl, ethyl, propyl, etc.), alkoxy groups having 1 to 10 carbon atoms (methoxy, ethoxy, etc.), acyl group having 1 to 10 carbon atoms (formyl, acetyl, etc.), alkoxycarbonyl group having 1 to 10 carbon atoms (methoxycarbonyl, ethoxycarbonyl, etc.), acyloxy groups having 1 to 10 carbon atoms (acetyloxy, propionyloxy, etc.), nitro group, trifluoromethyl group and difluoromethyl group.

Basic skeletons of the preferable examples of the mesogen group represented by formula (II) are listed below. These groups may further be substituted by the above-described substituent having W¹ and W².

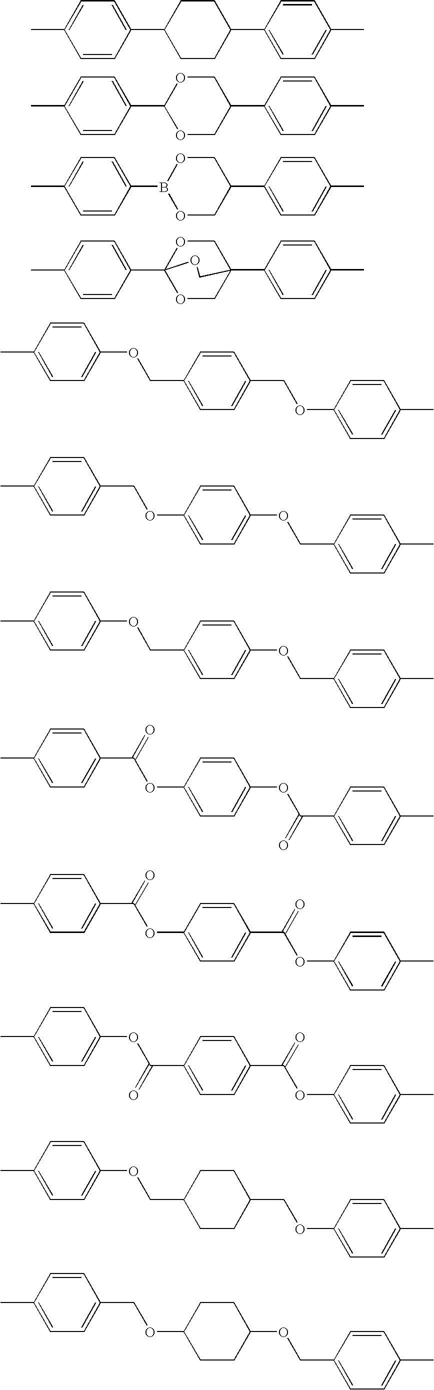

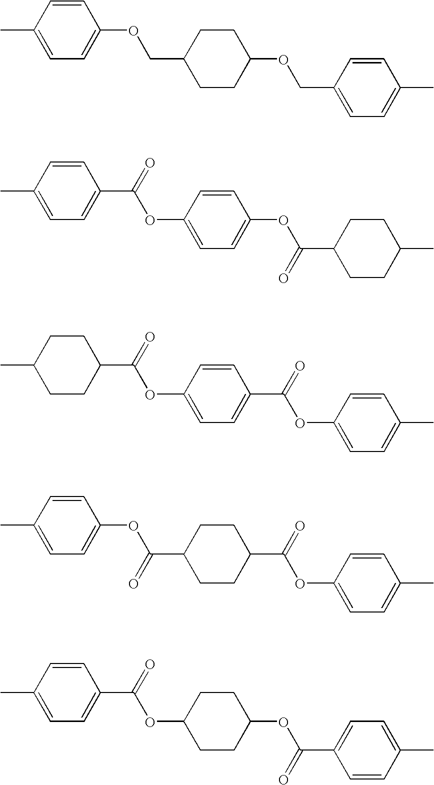

Examples of the compound represented by formula (I) include, but not to be limited to, those described below. The compounds represented by formula (I) may be prepared according to a method described in JP-T-11-513019 (WO 97/00600).

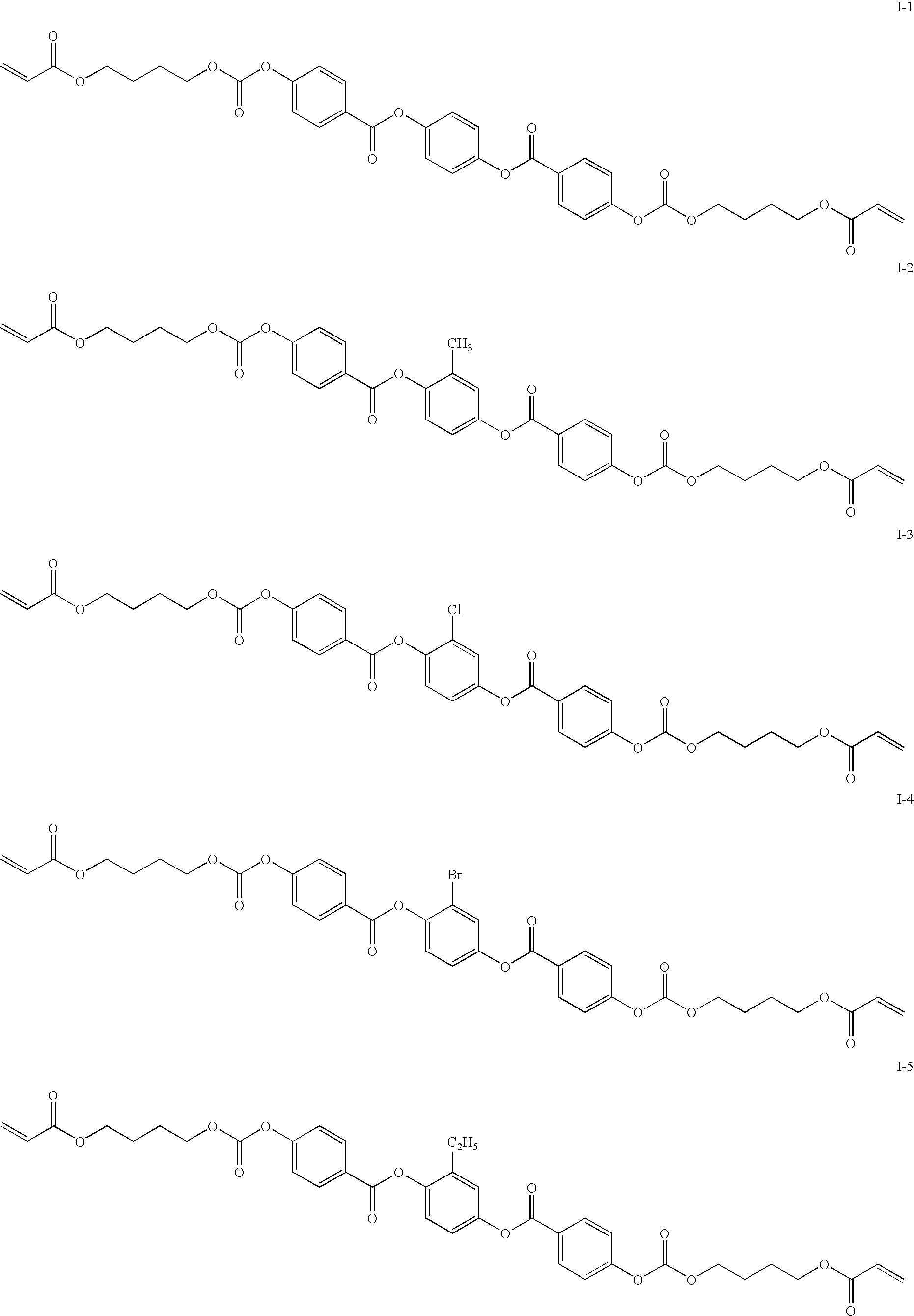

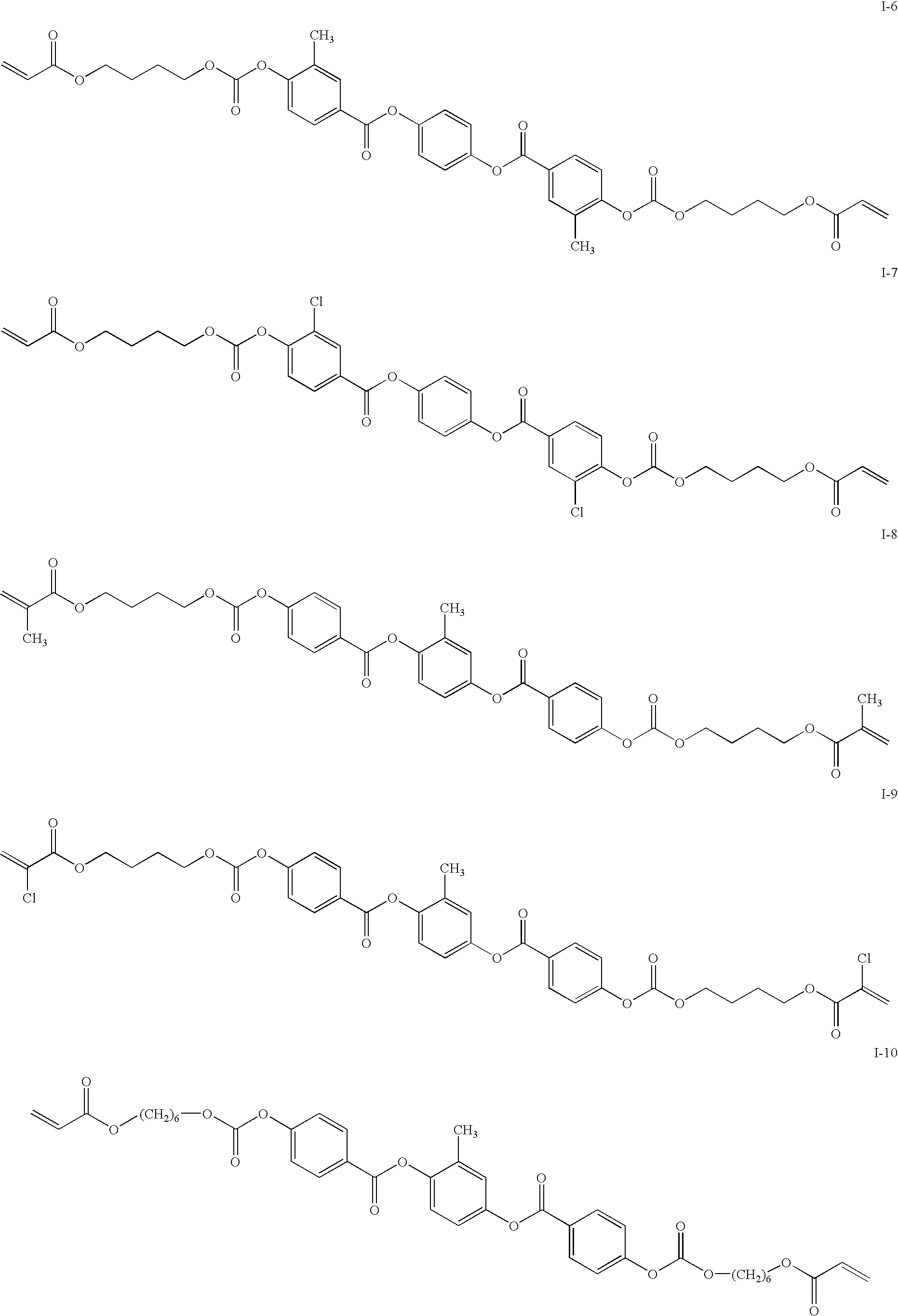

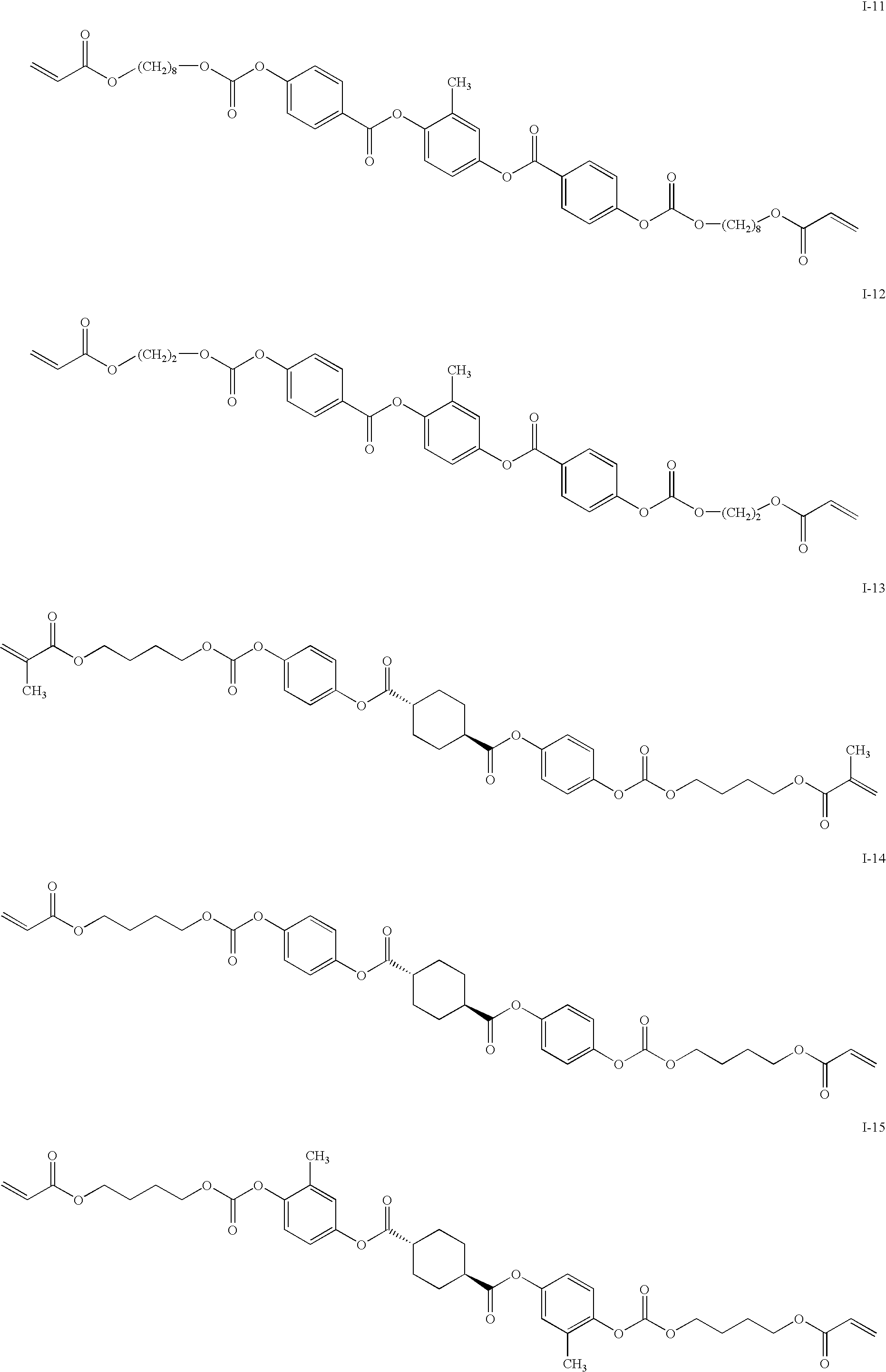

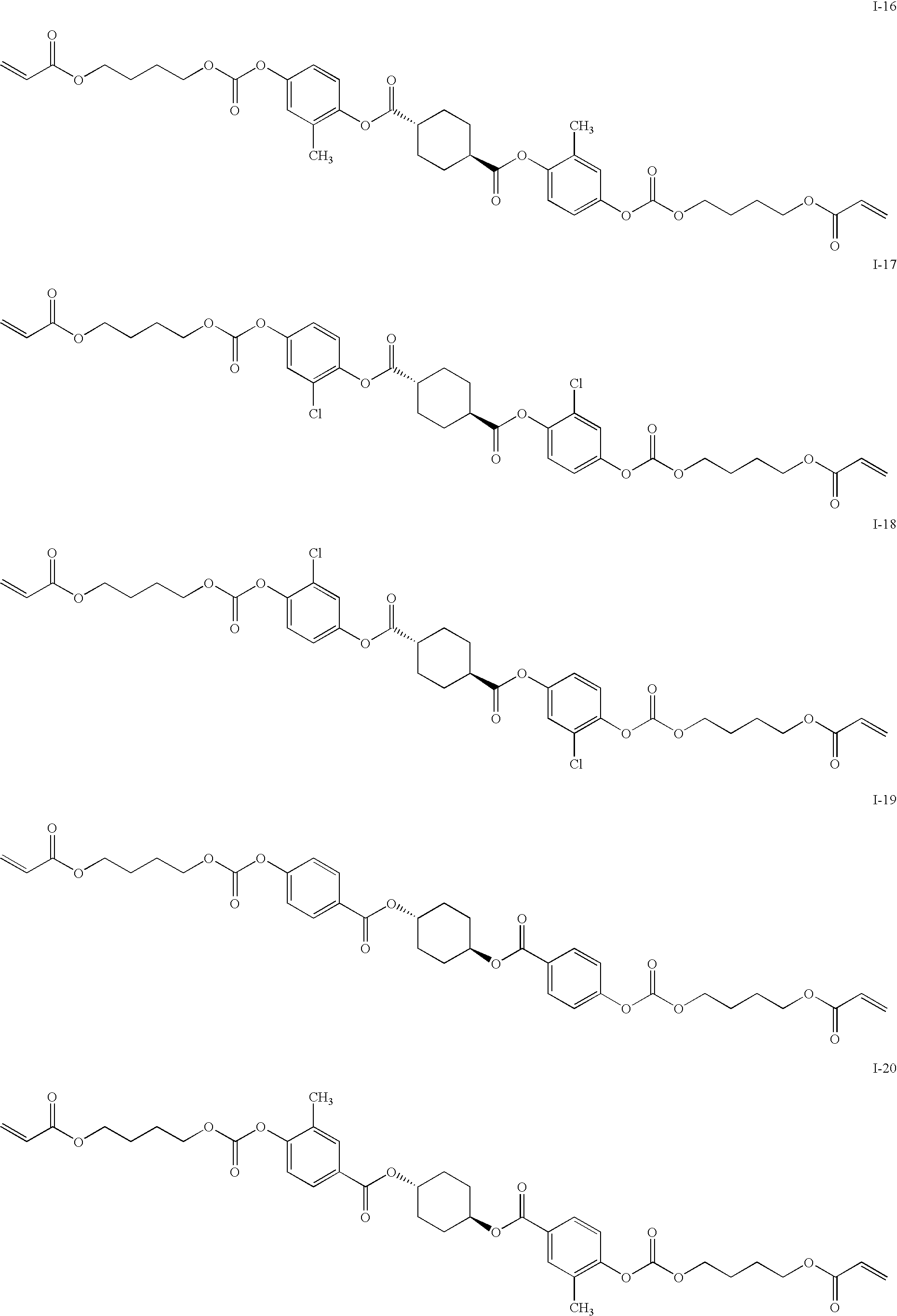

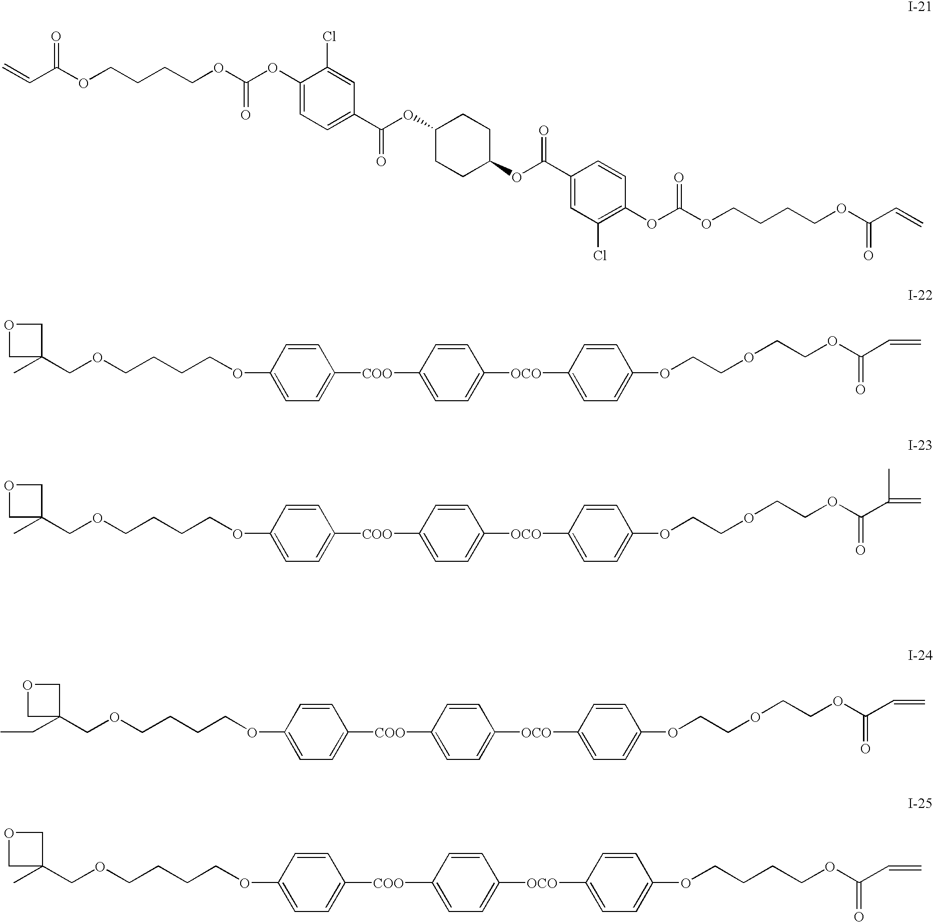

In another aspect of the present invention, a discotic liquid crystalline is used in the optically anisotropic layer. The optically anisotropic layer is preferably a layer of a low-molecular-weight liquid-crystalline discotic compound such as monomer or a layer of a polymer obtained by polymerization (curing) of a polymerizable liquid-crystalline discotic compound. Examples of the discotic (disk-like) compounds include benzene derivatives disclosed in a study report of C. Destrade et al., Mol. Cryst., vol. 71, page 111 (1981); truxene derivatives disclosed in a study report of C. Destrade et al., Mol. Cryst., vol. 122, page 141 (1985), and Phyics. Lett., A, vol. 78, page 82 (1990); cyclohexane derivatives disclosed in a study report of B. Kohne et al., Angew. Chem. vol. 96, page 70 (1984); and azacrown series and phenylacetylene series macrocycles disclosed in a study report of J. M. Lehn et al., J. Chem. Commun. page 1794 (1985), and a study report of J. Zhang et al., J. Am. Chem. Soc. vol. 116, page 2655 (1994). The above mentioned discotic (disk-like) compounds generally have a discotic core in the central portion and groups (L), such as linear alkyl or alkoxy groups or substituted benzoyloxy groups, which are substituted radially from the core. Among them, there are compounds exhibiting liquid crystallinity, and such compounds are generally called as discotic liquid crystalline. However, such molecular assembly in uniform orientation shows negative uniaxiality, although it is not limited to the description.

In the present invention, it is preferred to use the discotic liquid-crystalline compound represented by formula (III).

D(-L-P)n² Formula (III)

In formula (III), D represents a disc core; L represents a divalent linking group; P is a polymerizable group; and n² represents an integer of 4 to 12.

Preferable examples of the disc core (D), the divalent linking group (L) and the polymerizable group (P) in formula (III) are (D1) to (D15), (L1) to (L25), and (P1) to (P18), respectively, described in JP-A-2001-4837; and the contents of the patent publication are preferably employed in the present invention.

Preferred examples of the above discotic compound include compounds disclosed in paragraph Nos. [0045] to [0055] of JP-A-2007-121986.

The optically anisotropic layer is preferably a layer formed according to a method comprising applying a composition containing liquid crystalline compound (e.g., a coating liquid) to a surface of an alignment layer, described in detail later, aligning liquid crystalline molecules as to make an aligned state exhibiting a desired crystalline phase, and fixing the aligned state under applying heating or irradiating ionizing radiation.

When a discotic liquid crystalline compound having reactive groups is used as the liquid crystalline compound, the discotic molecules in the layer may be fixed in any alignment state such as a horizontal alignment state, vertical alignment state, tilted alignment state, and twisted alignment state. In the present specification, the term “horizontal alignment” means that, regarding rod-like liquid-crystalline molecules, the molecular long axes thereof and the horizontal plane of a transparent support are parallel to each other, and, regarding discotic liquid-crystalline molecules, the disk-planes of the cores thereof and the horizontal plane of a transparent support are parallel to each other. However, they are not required to be exactly parallel to each other, and, in the present specification, the term “horizontal alignment” should be understood as an alignment state in which molecules are aligned with a tilt angle against a horizontal plane less than 10°. The tilt angle is preferably from 0° to 5°, more preferably 0° to 3°, much more preferably from 0° to 2°, and most preferably from 0° to 1°.

A description is given below of an optically anisotropic layer having a birefringent pattern in which a liquid crystalline compound is oriented in a substantially constant direction. This is an example of patterning in which the retardation value is controlled, while the liquid crystalline compound in the layer is oriented in the same direction.

As mentioned above, the optically anisotropic layer having a pattern of optical axis directions may be obtained by the method described in JP-T-2001-525080. The control of the direction of the orientation of the liquid crystalline compound in the layer may be used in combination with the retardation value control described later, so that an optically anisotropic layer having a desired pattern of retardations and orientation directions can be produced.

When two or more optically anisotropic layers formed of the compositions containing liquid-crystalline compounds are stacked, the combination of the liquid-crystalline compounds is not particularly limited, and the combination may be a stack formed of layers all comprising discotic liquid-crystalline compounds, a stack formed of layers all comprising rod-like liquid-crystalline compounds, or a stack formed of a layer comprising discotic liquid-crystalline compounds and a layer comprising rod-like liquid-crystalline compounds. Combination of orientation state of the individual layers also is not particularly limited, allowing stacking of the optically anisotropic layers having the same orientation states, or stacking of the optically anisotropic layer having different orientation states.

The optically-anisotropic layer is preferably formed by applying a coating solution, which contains at least one liquid-crystalline compound, the following polymerization initiator and other additives, on a surface of an alignment layer described below. Organic solvents are preferably used as a solvent for preparing the coating solution, and examples thereof include amides (e.g., N,N-dimethylformamide), sulfoxides (e.g., dimethylsulfoxide), heterocyclic compounds (e.g., pyridine), hydrocarbons (e.g., benzene, hexane), alkyl halides (e.g., chloroform, dichloromethane), esters (e.g., methyl acetate, butyl acetate), ketones (e.g., acetone, methylethylketone), and ethers (e.g., tetrahydrofuran, 1,2-dimethoxyethane). In particular, alkyl halides and ketones are preferable. Two or more kinds of organic solvents may be used in combination.

### (Fixing of Liquid-Crystalline Compounds in an Alignment State)

It is preferred that the liquid-crystalline compounds in an alignment state are fixed without disordering the state. Fixing is preferably carried out by the polymerization reaction of the reactive groups contained in the liquid-crystalline compounds. The polymerization reaction includes thermal polymerization reaction using a thermal polymerization initiator and photo-polymerization reaction using a photo-polymerization initiator. Photo-polymerization reaction is preferred. Photo-polymerization reaction may be any of radical polymerization and cation polymerization. Examples of the radical photo-polymerization initiators include α-carbonyl compounds (described in U.S. Pat. Nos. 2,367,661 and 2,367,670), acyloin ethers (described in U.S. Pat. No. 2,448,828), α-hydrocarbon-substituted aromatic acyloin compounds (described in U.S. Pat. No. 2,722,512), polynuclear quinone compounds (described in U.S. Pat. Nos. 3,046,127 and 2,951,758), combinations of a triarylimidazole dimer with p-aminophenyl ketone (described in U.S. Pat. No. 3,549,367), acridine and phenazine compounds (described in JP-A-60-105667 and U.S. Pat. No. 4,239,850), and oxadiazol compounds (described in U.S. Pat. No. 4,212,970). As the cationic-polymerization initiator, examples include organic sulfonium salts, iodonium salts, and phosphonium salts. The organic sulfonium salts are preferred, and triphenyl sulfonium salts are particularly preferred. As a counter ion of these compounds, hexafluoroantimonate, hexafluorophosphate, or the like is preferably used.

It is preferable to use the photopolymerization initiator in an amount of 0.01 to 20 mass %, more preferably 0.5 to 5 mass %, based on the solid content in the coating solution. In the photoirradiation for polymerizing the liquid crystalline compounds, it is preferable to use ultraviolet ray. The irradiation energy is preferably from 10 mJ/cm² to 10 J/cm², more preferably from 25 to 800 mJ/cm². Illuminance is preferably 10 to 1,000 mW/cm², more preferably 20 to 500 mW/cm², and further preferably 40 to 350 mW/cm². The irradiation wavelength has a peak falling within the range from preferably 250 to 450 nm, more preferably 300 to 410 nm. Irradiation may be carried out in an atmosphere of inert gas such as nitrogen gas and/or under heating to facilitate the photo-polymerization reaction.

### (Orientation Induced by Irradiation of Polarized Light (Photoinduced Orientation))

The optically anisotropic layer may exhibit or enhance in-plane retardation attributed to photoinduced orientation with the aid of polarized light irradiation. The polarized light irradiation may be carried out in photo-polymerization process in the fixation of orientation, or the polarized light irradiation may precede and then may be followed by non-polarized light irradiation for further fixation, or the non-polarized light irradiation for fixation may precede and the polarized light irradiation may succeed for the photoinduced orientation. It is preferred that only the polarized light irradiation is conducted or the polarized light irradiation precedes and is followed by non-polarized light irradiation for further fixation. When the polarized light irradiation is carried out in photo-polymerization process in the fixation of orientation and a radical photo-polymerization initiator is used as the photo-polymerization initiator, the polarized light irradiation is preferably carried out under an inert gas atmosphere having an oxygen concentration of 0.5% or below. The irradiation energy is preferably 20 mJ/cm² to 10 J/cm², and more preferably 100 mJ/cm² to 800 mJ/cm². The illuminance is preferably 20 to 1,000 mW/cm², more preferably 50 to 500 mW/cm², and still more preferably 100 to 350 mW/cm². Types of the liquid-crystalline compound to be cured by the polarized light irradiation are not particularly limited, wherein the liquid-crystalline compound having an ethylenically unsaturated group as the reactive group is preferable. It is preferred that the irradiation light to be used has a peak falling within the range from 300 to 450 nm, more preferred from 350 to 400 nm.

(Post-Curing with UV-Light Irradiation after Irradiation of Polarized Light)

After the first irradiation of polarized light for photoinduced orientation (the irradiation for photoinduced orientation), the optically anisotropic layer may be irradiated with polarized or non-polarized ultraviolet light so as to improve the reaction rate (post-curing step) of the reactive groups. As a result, the adhesiveness is improved and, thus, the optically anisotropic layer can be produced with larger feeding speed. The post-curing step may be carried out with polarized or non-polarized light, and preferably with polarized light. Two or more steps of post-curing are preferably carried out with only polarized light, with only non-polarized light or with combination of polarizing and non-polarized light. When polarized and non-polarized light are combined, irradiating with polarized light previous to irradiating with non-polarized light is preferred. The irradiation of UV light may be or may not be carried out under an inert gas atmosphere. However, when a radical photo-polymerization initiator is used as the photo-polymerization initiator, the irradiation may be carried out preferably under an inert gas atmosphere where the oxygen gas concentration is 0.5% or lower. The irradiation energy is preferably 20 mJ/cm² to 10 J/cm², and more preferably 100 to 800 mJ/cm². The illuminance is preferably 20 to 1,000 mW/cm², more preferably 50 to 500 mW/cm², and still more preferably 100 to 350 mW/cm². As the irradiation wavelength, the irradiation of polarized light has a peak falling within the range preferably from 300 to 450 nm, more preferably from 350 to 400 nm. The irradiation of non-polarized light has a peak falling within the range preferably from 200 to 450 nm, more preferably from 250 to 400 nm.

### (Fixing the Orientation State of Liquid-Crystalline Compounds Having Radically Reactive Group and Cationically Reactive Group)

As described above, it is also preferred that liquid-crystalline compound has two or more kinds of reactive groups which have different polymerization condition to each other. In such a case, an optically anisotropic layer comprising a polymer having an unreacted reactive group can be produced by polymerizing only one kind of reactive groups among plural kinds of reactive groups by selecting polymerization condition. The conditions which are suitable for the polymerization and fixation of the liquid-crystalline compounds having radically reactive group and cationically reactive group (the aforementioned I-22 to I-25 as specific examples) are explained below.

First, as the polymerization initiator, only a photopolymerization initiator which acts on a reactive group intended to be polymerized is preferred to be used. That is, it is preferred that, only radical photopolymerization initiator is used when radically reactive groups are selectively polymerized, and only cationic photopolymerization initiator is used when cationically reactive groups are selectively polymerized. The content of the photopolymerization initiator falls in the range preferably from 0.01 to 20% by mass, more preferably from 0.1 to 8% by mass, and further preferably from 0.5 to 4% by mass of the total solid content in the coating solution.

Second, light irradiation for the polymerization is preferably conducted by using ultraviolet ray. When the irradiation energy and/or illuminance are too high, non-selective reaction of both of the radically reactive group and cationically reactive group is of concern. In view of the above, the irradiation energy is preferably 5 mJ/cm² to 500 mJ/cm², more preferably 10 to 400 mJ/cm², and particularly preferably 20 to 200 mJ/cm². The illuminance is preferably 5 to 500 mW/cm², more preferably 10 to 300 mW/cm², and particularly preferably 20 to 100 mW/cm². As the irradiation wavelength, the light has a peak falling within the range preferably from 250 to 450 nm, more preferably from 300 to 410 nm.

Among photopolymerization reaction, the reaction by using a radical photopolymerization initiator is inhibited by oxygen, and the reaction by using a cationic photopolymerization initiator is not inhibited by oxygen. Therefore, when one of the reactive groups of the liquid-crystalline compounds having radically reactive group and cationically reactive group is selectively reacted, it is preferred that the light irradiation is carried out in an atmosphere of inert gas such as nitrogen gas when the radically reactive group is selectively reacted, and in an atmosphere containing oxygen (for example, in air atmosphere) when the cationically reactive group is selectively reacted.

### (Horizontal Orientation Agent)

At least one compound selected from the group consisting of the compounds represented by formula (1), (2) or (3), and fluorine-containing homopolymer or copolymer using the monomer represented by formula (4), which are shown below, may be added to the composition used for forming the optically anisotropic layer, in order to align the molecules of the liquid-crystalline compounds substantially horizontally.

The formulae (1) to (4) will be described in detail below.

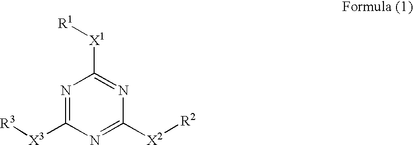

In formula (1), R¹, R² and R³ each independently represent a hydrogen atom or a substituent; and X¹, X² and X³ each independently represent a single bond or a divalent linking group. As the substituent represented by R¹, R² and R³, preferred is a substituted or unsubstituted alkyl group (preferably an unsubstituted alkyl group or a fluorine-substituted alkyl group), a substituted or unsubstituted aryl group (preferably an aryl group having a fluorine-substituted alkyl group), a substituted or unsubstituted amino group, a substituted or unsubstituted alkoxy group, a substituted or unsubstituted alkylthio group or a halogen atom. In formula (I), the divalent linking group represented by X¹, X² and X³ is preferably selected from the group consisting of an alkylene group, an alkenylene group, a divalent aromatic group, a divalent heterocyclic group, —CO—, —NR^{a}— (in which R^{a} represents an alkyl group having 1 to 5 carbon atoms, or a hydrogen atom), —O—, —S—, —SO—, —SO₂—, and a group made by any combination of two or more kinds thereof; and more preferably a divalent linking group selected from the group consisting of an alkylene group, a phenylene group, —CO—, —NR^{a}—, —O—, —S—, and —SO₂—, and a group made by any combination of at least two kinds thereof. The alkylene group preferably has 1 to 12 carbon atoms. The alkenylene group preferably has 2 to 12 carbon atoms. The divalent aromatic group preferably has 6 to 10 carbon atoms.

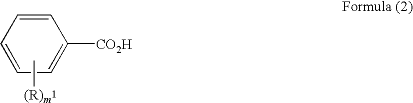

In formula (2), R represents a substituent, and m¹ represents an integer of 0 to 5. When m¹ is 2 or more, plural R's may be the same or different to each other. Preferable examples of the substituent represented by R are the same as the examples listed above for each of R¹, R² and R³. m¹ is preferably an integer of 1 to 3, more preferably 2 or 3.

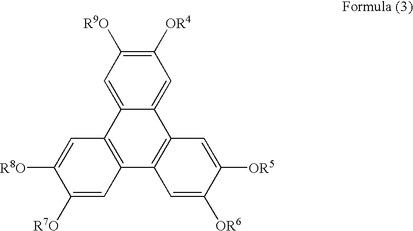

In formula (3), R⁴, R⁵, R⁶, R⁷, R⁸ and R⁹ each independently represent a hydrogen atom or a substituent. Preferable examples of the substituent represented by each of R⁴, R⁵, R⁶, R⁷, R⁸ and R⁹ are the same as the examples listed above for each of R¹, R² and R³ in formula (I). Examples of the horizontal orientation agent, which can be used in the present invention, include those described in paragraphs (0092) to (0096) in JP-A-2005-099248 and the methods for preparing such compounds are described in the document.

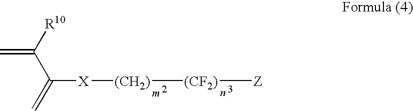

In formula (4), R¹⁰ represents a hydrogen atom or a methyl group, X represents an oxygen atom or a sulfur atom, Z represents a hydrogen atom or a fluorine atom; m² represents an integer of 1 to 6, and n³ represents an integer of 1 to 12. In addition to the fluorine-containing polymer prepared by using the monomer represented by formula (4), the polymer compounds described in JP-A-2005-206638 and JP-A-2006-91205 can be used as horizontal orientation agents for reducing unevenness in coating. The methods of preparation of the compounds are also described in the publications.

The amount of the horizontal orientation agents added is preferably 0.01 to 20% by mass, more preferably 0.01 to 10% by mass, and most preferably 0.02 to 1% by mass with respect to the mass of the liquid crystalline compound. The compounds represented by any of the aforementioned formulae (1) to (4) may be used singly, or two or more types of them may be used in combination.

### (Optically Anisotropic Layer Produced by Stretching)

The optically anisotropic layer may be produced by stretching a polymer. When a polymer in the optically anisotropic layer, which is preferred to have at least one unreacted reactive group as described above, is produced, a polymer having a reactive group may be stretched or a reactive group may be introduced by using a coupling agent or the like to an optically anisotropic layer prepared by stretching. The characteristics of the optically anisotropic layer obtained by stretching include low cost, self-supporting property (a support is not needed when the layer is formed or maintained), and the like.

### (Post-Treatment of Optically Anisotropic Layer)

Various post-treatments may be conducted to modify the optically anisotropic layer produced. Examples of the post treatments include corona treatment for improving adhesiveness, addition of a plasticizer for improving plasticity, addition of a heat polymerization inhibitor for improving storage stability, and coupling treatment for improving reactivity. When the polymer in the optically anisotropic layer has an unreacted reactive group, addition of a polymerization initiator suited to the reactive group may also be a useful modification method. For example, by addition of a radical photopolymerization initiator to an optically anisotropic layer fixed by polymerization of a liquid crystalline compound having a cationically reactive group and a radically reactive group by using a cationic photopolymerization initiator, the reaction of the unreacted radically reactive group in the patterned light exposure afterward can be promoted. As the method of addition of the plasticizer or the photopolymerization initiator, examples include immersing the optically anisotropic layer in a solution of the desired additive, and applying a solution of the desired additive to the optically anisotropic layer for the permeance of the solution. Further, when another layer is applied to the optically anisotropic layer, the desired additive may be added to the coating solution of the layer for permeance to the optically anisotropic layer. In the present invention, it is possible, by properly selecting the kind and the amount of the additive used for penetration, in particular of the photopolymerization initiator, to adjust the relationship between the exposure quantity to respective regions during pattern exposure of the birefringent pattern builder and the retardation of the regions finally obtained and thus make the final product have material properties closer to desirable values.

### (Materials Used to Form Birefringent Pattern Member Except for Optically Anisotropic Layer)

The builder that includes the optically anisotropic layer and is used to form the birefringent pattern member (hereinafter referred to as “birefringent pattern builder”) is a material used to form the birefringent pattern, with which the birefringent pattern member is obtained through a predetermined process. The birefringent pattern builder may include a functional layer which can be applied with various subsidiary functions, other than the optically anisotropic layer. Examples of the functional layer include an adhesive layer, a reflective layer, a protective layer, and the like.

In view of the heat resistance or the like of the resin used to form the packaging material, the optically anisotropic layer is preferably attached to the support by the transfer method. The use of the transfer method leads to the advantage that such a process load as thermal damage to the substrate of the packaging material can be reduced in the process of forming the optically anisotropic layer and additionally, any layer that will be unnecessary for the packaging material, such as the alignment layer can be removed. The birefringent pattern builder for use as a transfer material or the birefringent pattern builder produced with a transfer material may have a temporary support, a transfer adhesive layer, or a mechanical characteristic control layer.

Packaging material-forming layers other than the optically anisotropic layer are formed so as to have a retardation not affecting the formation of the latent image. Therefore, the value of the retardation of the optically anisotropic layer to form the latent image may be set taking into account the retardation of these layers.

### [Support]

The birefringent pattern member has a substrate not having undergone any retardation-imparting process. The retardation of the substrate may be 2,000 nm or less, preferably 1,000 nm or less, more preferably 500 nm or less. The lower limit of the retardation is preferably, but not limited to, 0 nm. The substrate may include the support described below.

The birefringent pattern member preferably has a transparent support or a reflective support. When the latent image is manifested using reflected light, the support to be used may be, but not limited to, a support having a reflective layer or a support having a reflection function as described later. When the latent image is manifested using transmitted light, the support to be used may be, but not limited to, a transparent support having optical properties not affecting the latent image.

As such a support, examples include plastic films such as cellulose ester (for example, cellulose acetate, cellulose propionate, and cellulose butyrate), polyolefin (for example, norbornene based polymer), poly(meth)acrylate (for example, polymethylmethacrylate), polycarbonate, polyester, polysulfone, and norbornene based polymer. The thickness of the support is preferably 3 to 500 μm, more preferably 10 to 200 μm, when the support is subjected to a continuous process such as a roll-to-roll process, although it may be selected, as needed, depending on the manufacturing mode. When the optically anisotropic layer is formed directly on the support, the support should preferably have heat resistance at such a level that it will not be colored or deformed by the baking described later.

The birefringent pattern member may include a colored support. Specifically, the birefringent pattern member may have a drawn pattern that is visible without using any recognition or authentication device. When the birefringent pattern is read in a specific color, the support to be used may be colored with any color other than the specific color, because it is not affected by the other color.

The optically anisotropic layer may be formed so as to be embedded in the support. Since the optically anisotropic layer according to the invention has a high level of various types of resistance, it may also be formed on a film by a process including transferring the optically anisotropic layer onto an endless belt or a drum in a casting apparatus, casting a molten material for the support on the optically anisotropic layer, and forming them into a film by the desired process such as shaping, rolling or stretching similarly to the process of forming a general polymer film. Alternatively, the optically anisotropic layer may be sandwiched between two supports to form the packaging material.

Resins having a melting temperature equal to or lower than the temperature at which the properties of the optically anisotropic layer are not degraded may be used for the packaging material.

A stretching process can produce tearing properties to improve the openability. Therefore, taking the product form into account, various known processes may be added to the manufacturing process, because various mechanical properties can be expected to be imparted.

### [Alignment Layer]

As described above, an alignment layer may be used for forming the optically anisotropic layer. The alignment layer may be generally formed on the surface of a support or a temporary support, or on the surface of an undercoating layer formed on the support or the temporary support. The alignment layer has function of controlling the orientation direction of liquid crystalline compounds provided thereon, and, as far as having such a function of giving the orientation to the optically anisotropic layer, may be selected from various known alignment layers. The alignment layer that can be employed in the present invention may be provided by rubbing a layer formed of an organic compound (preferably a polymer), oblique vapor deposition of an inorganic compound, formation of a layer with microgrooves, or the deposition of w-tricosanoic acid, dioctadecylmethylammonium chloride, methyl stearate or the like by the Langmuir-Blodgett (LB) film method. Further, alignment layers in which dielectric is oriented by applying an electric or magnetic field are also exemplified.

Examples of the organic compound, which can be used for forming the alignment layer, include polymers such as polymethyl methacrylate, acrylic acid/methacrylic acid copolymer, styrene/maleimide copolymer, polyvinyl alcohol, poly(N-methyrol acrylamide), polyvinylpyrrolidone, styrene/vinyl toluene copolymer, chlorosulfonated polyethylene, nitrocellulose, polyvinyl chloride, chlorinated polyolefin, polyester, polyimide, vinyl acetate/vinyl chloride copolymer, ethylene/vinyl acetate copolymer, carboxymethyl cellulose, polyethylene, polypropylene, and polycarbonates; and compounds such as silane coupling agents. Preferred examples of the polymer include polyimide, polystyrene, styrene based polymers, gelatin, polyvinyl alcohol and alkyl-modified polyvinyl alcohol having at least one alkyl group (preferably an alkyl group having carbon atoms of 6 or more).

For formation of an alignment layer, a polymer may preferably used. The types of the polymer, which can be used for forming the alignment layer, may be decided depending on what types of alignment of liquid crystalline compound (in particular, the average tilt angle). For example, for forming an alignment layer capable of aligning liquid crystalline compounds horizontally, a polymer which does not lower the surface energy of the alignment layer (a usual polymer for forming alignment layer) is used. Specifically, kinds of such a polymer are described in various documents concerning liquid crystalline cells or optical compensation sheets. For example, polyvinyl alcohols, modified polyvinyl alcohols, copolymers with polyacrylic acid or polyacrylate, polyvinyl pyrrolidone, cellulose and modified cellulose are preferably used. Materials used for producing the alignment layer may have a functional group capable of reacting with the reactive group of the liquid crystalline compound. Examples of the polymer having such a functional group include polymers comprising a repeating unit having such a functional group in the side chain, and polymers having a cyclic moiety substituted with such a functional group. It is more preferable to use an alignment layer capable of forming a chemical bond with the liquid-crystalline compound at the interface, and a particularly preferable example of such alignment layer is a modified polyvinyl alcohol, described in JP-A-9-152509, which has an acrylic group introduced in the side chain thereof using acid chloride or Karenz MOI (trade name, manufactured by Showa Denko K. K.). The thickness of the alignment layer is preferably 0.01 to 5 μm, and more preferably 0.05 to 2 μm. The alignment layer may function as an oxygen insulation layer.

Polyimide film which has been widely used as an alignment layer for LCD (preferably a layer composed of a fluorine-atom-containing polyimide) is also preferable as the organic alignment layer. The film may be formed by applying poly(amic acid), provided, for example, as LQ/LX series products by Hitachi Chemical Co., Ltd or as SE series products by NISSAN CHEMICAL INDUSTRIES, LTD, to a surface of the support, baking at 100 to 300° C. for 0.5 to one hour to form a polymer layer, and rubbing a surface of the polymer layer.

The rubbing treatment may be carried out with known techniques which have been employed in the usual step for aligning of liquid crystalline of LCD. In particular, the rubbing treatment may be carried out by rubbing a surface of the alignment layer in a direction, with paper, gauze, felt, rubber, nylon or polyester fiber or the like. The rubbing treatment is generally carried out, for example, by rubbing for several times with a cloth having the same length and the same diameter fibers grafted uniformly.

Examples of a deposition material used in the inorganic oblique vapor deposition film include metal oxides such as SiO₂, which is a typical material, TiO₂ and ZnO; fluorides such as MgF₂; metals such as Au and Al. Any high dielectric constant metal oxides can be used in oblique vapor deposition, and, thus, the examples thereof are not limited to the above mentioned materials. The inorganic oblique deposition film may be produced with a deposition apparatus. The deposition film may be formed by depositing on an immobile film (a support) or on a long film fed continuously.

### [Reflective Layer]

A reflective layer or a support having a reflection function may be used in the packaging material of the invention. The support having a reflection function refers to a material that has a reflection function by itself when used as a support, such as an aluminum foil. When the reflective layer or the support is observed from the patterned optically anisotropic layer side through a polarizing plate, the latent image based on the birefringent pattern can be visualized.

For example, the reflective layer may be, but not limited to, a metal layer such as an aluminum or silver layer. Such a metal layer may be vapor-deposited on the support or the birefringent pattern builder, or metal foil stamping may be performed. The packaging material having such a metal layer can improve the antistatic performance or the gas barrier properties and therefore is preferably used as a precision instrument packaging material or the like. Besides the metal layer, a support on which a print is made with gold or silver ink or the like may also be used. A complete minor surface is not always necessary, and the surface may be matted.

Alternatively, a transparent packaging material may be provided according to the invention, and a product (such as a box or a commercial product) having a glossy surface may be wrapped with the transparent packaging material, so that the same effect as that of the reflective layer can be obtained.

### [Post-Adhesive Layer]

The birefringent pattern builder may have a post-adhesive layer in order that the patterned birefringent member produced after the after-mentioned patterned light exposure and baking can be attached to another product. The material of the post-adhesive layer is not particularly limited, but preferred to be a material which has adhesiveness even after the baking step for production of the birefringence pattern.

### [Two or More Optically Anisotropic Layers]

The birefringent pattern builder may have two or more optically anisotropic layers. The two or more optically anisotropic layers may be adjacent to each other in direction of the normal line, or may sandwich another functional layer. The two or more optically anisotropic layers may have almost the same retardation to each other, or different retardation to each other. The slow axes of them may be in the same direction to each other, or different direction to each other.

As an example wherein a birefringent pattern builder having two or more optically anisotropic layers laminated so that the slow axis of each is in the same direction is used, a case of preparing a pattern having large retardation can be mentioned. Even when the existing optically anisotropic layer cannot satisfy the desired retardation in a single layer, a patterned optically anisotropic layer including a region having a larger retardation or a complex retardation gradation can be easily obtained by forming a laminate of two or more layers and then subjecting the laminate to pattern exposure.

A birefringent pattern builder having two or more optically anisotropic layers stacked with their slow axes oriented in different directions may also be used. In this case, for example, latent images may be arranged to vary from one slow axis direction to another.

### (Method of Producing Birefringent Pattern Builder)

The method of producing the birefringent pattern builder is not particularly limited. For example, the birefringent pattern builder may be produced by: directly forming an optically anisotropic layer on a support; transferring an optically anisotropic layer on a support by using another birefringent pattern builder used as a transferring material; forming a self-supporting optically anisotropic layer; forming another functional layer on a self-supporting optically anisotropic layer; attaching a support to a self-supporting optically anisotropic layer; or the like. Among these, in view of avoiding limitation to the property of the optically anisotropic layer, a method of direct formation of an optically anisotropic layer on a support and a method of transfer of an optically anisotropic layer on a support by using a transferring material are preferred. Further, in view of avoiding limitation to the support, a method of transferring of an optically anisotropic layer on a support by using a transferring material is more preferred.

As the method for producing the birefringent pattern builder having two or more optically anisotropic layers, the birefringent pattern builder may be produced by, for example, directly forming an optically anisotropic layer on a different birefringent pattern builder; transferring an optically anisotropic layer on a birefringent pattern builder by using a different birefringent pattern builder as a transferring material. Among these, transfer of an optically anisotropic layer on a birefringent pattern builder by using another birefringent pattern builder as a transferring material is more preferable.

A birefringent pattern builder used as a transferring material will be explained in the followings. A birefringent pattern builder used as a transferring material may be referred to as “transferring material for producing a birefringence pattern” in the specification especially in the after-mentioned Examples.

### [Temporary Support]

The birefringent pattern builder used as a transferring material is preferred to have a temporary support. The temporary support is not particularly limited and may be transparent or opaque. Examples of the polymer, which can constitute a temporary support, include cellulose ester (for example, cellulose acetate, cellulose propionate, and cellulose butyrate), polyolefin (for example, norbornene based polymer), poly(meth)acrylate (for example, polymethylmethacrylate), polycarbonate, polyester, polysulfone, and norbornene based polymer. For the purpose of optical property examination in a manufacturing process, the support is preferably selected from transparent and low-birefringence polymer films. Examples of the low-birefringence polymer films include cellulose ester films and norbornene based polymer films. Commercially available polymers such as a norbornene based polymer, “ARTON” provided by JSR and “ZEONEX” and “ZEONOR” provided by ZEON CORPORATION may be used. Polycarbonate, poly(ethylene terephthalate), or the like which is inexpensive, may also be preferably used.

### [Adhesive Layer for Transfer]

The transferring material is preferred to have an adhesive layer for transfer. The adhesive layer for transfer is not particularly limited as far as the layer is transparent and non-colored, and has sufficient property for transfer. Examples include adhesive layer using an adhesive agent, a pressure-sensitive resin layer, a heat-sensitive resin layer, and a photo-sensitive resin layer. Among these, the heat-sensitive resin layer and the photo-sensitive resin layer are preferred in view of heat-resistance (resistance to baking).

When polarized light passes through the adhesive layer for transfer in manifesting the latent image, the adhesive layer for transfer preferably has optical properties that do not affect the latent image as described in the section “Support.”Specifically, it is preferably isotropic or preferably has a retardation that does not affect the manifestation of the latent image.

The adhesive agent is preferred to exhibit, for example, good optical transparency, suitable wettability, and adhesive characteristics such as cohesiveness and adhesiveness. Specific examples are adhesive agents prepared using a suitable base polymer such as an acrylic polymer, silicone-based polymer, polyester, polyurethane, polyether, or synthetic rubber. The adhesive characteristics of the adhesive layer can be suitably controlled by conventionally known methods. These include adjusting the composition and/or molecular weight of the base polymer forming the adhesive layer, and adjusting the degree of crosslinking and/or the molecular weight thereof by means of the crosslinking method, the ratio of incorporation of crosslinking functional groups, and the crosslinking agent blending ratio.

The pressure-sensitive resin layer is not specifically limited as far as it exhibits adhesiveness when pressure is applied. Various adhesives, such as rubbers, acrylics, vinyl ethers, and silicones, can be employed as the pressure-sensitive adhesive. The adhesives may be employed in the manufacturing and coating stages in the form of solvent adhesives, non-water-based emulsion adhesives, water-based emulsion adhesives, water-soluble adhesives, hot melt adhesives, liquid hardening adhesives, delayed tack adhesives, and the like. Rubber adhesives are described in Shin Kobunshi Bunko 13 (the New Polymer Library 13), “Nenchaku Gijutu (Adhesion Techniques),” Kobunshi Kankokai (K. K.), p. 41 (1987). Examples of the vinyl ether adhesives include vinyl ether comprised mainly of alkyl vinyl ether compounds having 2 to 4 carbon atoms, and vinyl chloride/vinyl acetate copolymers, vinyl acetate polymers, polyvinyl butyrals, and the like, to which a plasticizer is admixed. With respect to the silicone adhesives, rubber siloxane can be used to impart film formation and condensation strength of the film, and resinous siloxane can be used to impart adhesiveness or tackiness.

The heat-sensitive resin layer is not specifically limited as far as it exhibits adhesiveness when heat is applied. Examples of the heat-sensitive adhesives include hot-melt compounds and thermoplastic resins. Examples of the hot-melt compounds include low molecular weight compounds in the form of thermoplastic resins such as polystyrene resin, acrylic resin, styrene-acrylic resin, polyester resin, and polyurethane resin; and various waxes in the form of vegetable waxes such as carnauba wax, Japan wax, candelilla wax, rice wax, and auricury wax; animal waxes such as beeswax, insect waxes, shellac, and whale wax; petroleum waxes such as paraffin wax, microcrystalline wax, polyethylene wax, Fischer-Tropshe wax, ester wax, and oxidized waxes; and mineral waxes such as montan wax, ozokerite, and ceresin wax. Further examples include rosin, hydrogenated rosin, polymerized rosin, rosin-modified glycerin, rosin-modified maleic acid resin, rosin-modified polyester resin, rosin-modified phenol resin, ester rubber, and other rosin derivatives; as well as phenol resin, terpene resin, ketone resin, cyclopentadiene resin, aromatic hydrocarbon resin, aliphatic hydrocarbon resin, and alicyclic hydrocarbon resin.

These hot-melt compounds preferably have a molecular weight of, usually 10,000 or less, particularly 5,000 or less, and a melting or softening point desirably falling within a range of 50° C. to 150° C. These hot-melt compounds may be used singly or in combinations of two or more. Examples of the above-mentioned thermoplastic resin include ethylene series copolymers, polyamide resins, polyester resins, polyurethane resins, polyolefin series resins, acrylic resins, and cellulose series resins. Among these, the ethylene series copolymers are preferably used.

The photosensitive adhesive may be of any type, as long as it exhibits adhesive properties upon photoirradiation. Preferably, the photosensitive adhesive is made from a resin composition including at least (1) a polymer, (2) a monomer or an oligomer, and (3) a photopolymerization initiator or a photopolymerization initiator system. In view of adhesion performance or production suitability, any appropriate additive such as a surfactant may also be added as needed to form the photosensitive adhesive composition to be used.

(1) The polymer is preferably an alkali-soluble resin comprising a polymer having a polar group such as a carboxylic acid group or a carboxylate group at its side chain. Examples of the polymer include a methacrylic acid copolymer, an acrylic acid copolymer, an itaconic acid copolymer, a crotonic acid copolymer, a maleic acid copolymer, and a partially esterified maleic acid copolymer described in, for example, JP-A-59-71048. The examples further include a cellulose derivative having a carboxylic acid group at its side chain. In addition to the foregoing, a product obtained by adding a cyclic acid anhydride to a polymer having a hydroxyl group can also be preferably used. In addition, the examples of the polymer include a copolymer of benzyl (meth)acrylate and (meth)acrylic acid and a multicomponent copolymer of benzyl (meth)acrylate, (meth)acrylic acid, and any other monomer, described in U.S. Pat. No. 4,139,391.
(2) The monomer or oligomer is preferably a monomer or oligomer which has two or more ethylenically unsaturated double bonds and which undergoes addition-polymerization by irradiation with light. Examples of such monomer or oligomer include a compound having at least one addition-polymerizable ethylenically unsaturated group in the molecule and having a boiling point of 100° C. or higher at normal pressure. Preferable examples thereof include: a monofunctional methacrylate; a polyfunctional acrylate or polyfunctional methacrylate which may be obtained by adding ethylene oxide or propylene oxide to a polyfunctional alcohol such as trimethylolpropane or glycerin and converting the adduct into a (meth)acrylate; urethane acrylates; polyester acrylates; and polyfunctional acrylates or polyfunctional methacrylates such as an epoxy acrylate which is a reaction product of an epoxy resin and (meth)acrylic acid; and “polymerizable compound [B]” described in JP-A-11-133600 can be mentioned as a preferable example. These monomers or oligomers may be used singly or as a mixture of two or more kinds thereof.
(3) Any initiator (system) compatible with (2) the monomer or oligomer may be selected as the photopolymerization initiator or the photopolymerization initiator system. Preferable examples of the photopolymerization initiator or the photopolymerization initiator system (in the present specification, the term “photo-polymerization initiator system” means a polymerization initiating mixture that exhibits a function of photo-polymerization initiation with a plurality of compounds combined with each other) include vicinal polyketaldonyl compounds, acyloin ether compounds, aromatic acyloin compounds substituted by an α-hydrocarbon, polynuclear quinone compounds, combinations of triarylimidazole dimer and p-aminoketone, benzothiazole compounds, trihalomethyl-s-triazine compounds, trihalomethyloxadiazole compounds; and “polymerization initiator C” described in JP-A-11-133600. These may be used singly or as a mixture of two or more kinds thereof.

### (Dynamic Property Control Layer)

Between the temporary support and the optically anisotropic layer of the transferring material, a dynamic property control layer to control mechanical characteristics and conformity to irregularity may be preferably provided. The dynamic property control layer preferably exhibit flexible elasticity, is softened by heat, or fluidize by heat. A thermoplastic resin layer is particularly preferred for the dynamic property control layer. The component used in the thermoplastic resin layer is preferably an organic polymer substance described in JP-A-5-72724. The substance can be preferably selected from organic polymer substances having a softening point of about 80° C. or lower according to the Vicat method (specifically, the method of measuring a polymer softening point according to American Material Test Method ASTMD 1235). More specifically, examples include: a polyolefin such as polyethylene or polypropylene; an ethylene copolymer such as a copolymer of ethylene and vinyl acetate or a saponified product thereof; a copolymer of ethylene and an acrylate or a saponified product thereof; polyvinyl chloride; a vinyl chloride copolymer such as a copolymer of vinyl chloride and vinyl acetate or a saponified product thereof; apolyvinylidene chloride; a vinylidene chloride copolymer; polystyrene; a styrene copolymer such as a copolymer of styrene and a (meth)acrylate or a saponified product thereof; polyvinyl toluene; a vinyltoluene copolymer such as a copolymer of vinyltoluene and a (meth)acrylate or a saponified product thereof; a poly(meth)acrylate; a (meth)acrylate copolymer such as a copolymer of butyl (meth)acrylate and vinyl acetate; and a polyamide resin such as a vinyl acetate copolymer nylon, a copolymerized nylon, N-alkoxymethylated nylon, and N-dimethylaminated nylon.

### [Intermediate Layer]

The transferring material preferably has an intermediate layer for the purpose of preventing mixing of the components during coating of a plurality of layers and during storage after the coating. The oxygen shut-off film having an oxygen shut-off function described as “separation layer” in JP-A-5-72724 or the above-described orientation layer for generating optical anisotropy is preferably used as the intermediate layer. Particularly preferably among them is a layer containing a mixture of polyvinylalcohol or polyvinylpyrrolidone and one or more derivatives thereof. One layer may work simultaneously as the above thermoplastic resin layer, oxygen shut-off layer, and alignment layer.

### [Delamination Layer]

The birefringent pattern builder used as a transferring material may include a delamination layer on the temporary support. The delamination layer controls the adhesion between the temporary support and the delamination layer or between the delamination layer and the layer laminated immediately above, and takes a role of helping the separation of the temporary support after the transfer of the optically anisotropic layer. The above-mentioned other functional layers such as the alignment layer, the dynamic property control layer, and the intermediate layer may function as the delamination layer.

### [Surface Protecting Layer]

A surface protecting layer having anti-fouling or hard-coating properties is preferably formed on the surface of the birefringent pattern member in order to protect the surface from fouling or damage. The properties of the surface protecting layer are not limited. The surface protecting layer may be produced using known materials and may be made of the same or similar material as the support (temporary support) or any other functional layer.

For example, the surface protecting layer may be an anti-fouling layer made of fluororesin such as polytetrafluoroethylene or a hard coat layer made of acrylic resin including polyfunctional acrylate. In addition, an anti-fouling layer may be placed on a hard coat layer, and the protecting layer may be placed on the optically anisotropic layer or any other functional layer.

### [Other Functional Layers]

The functional layers described above may be used in combination with a variety of other functional layers such as: a functional layer that causes destruction or an optical property change to make it impossible to separate and reuse the birefringent pattern member; and a latent image layer that makes possible a combination with any other security technique such as a technique of manifesting a latent image with invisible light. Any other layer of the packaging material may be formed so as to have a retardation that does not affect the formation of the latent image or may be provided taking into account the retardation of such a layer or the retardation value necessary for the formation of the latent image in the optically anisotropic layer.

The individual layers of the optically anisotropic layer, photosensitive resin layer, adhesive layer for transfer, and optionally-formed alignment layer, thermoplastic resin layer, dynamic property control layer, and intermediate layer can be formed by coating such as dip coating, air knife coating, spin coating, slit coating, curtain coating, roller coating, wire bar coating, gravure coating and extrusion coating (U.S. Pat. No. 2,681,294). Two or more layers may be coated simultaneously. Methods of simultaneous coating is described in U.S. Pat. Nos. 2,761,791, 2,941,898, 3,508,947, 3,526,528, and in “Kotingu Kogaku (Coating Engineering)”, written by Yuji Harazaki, p. 253, published by Asakura Shoten (1973).

When the layer immediately above the optically anisotropic layer (for example, the adhesive layer for transfer) is applied to the optically anisotropic layer, the coating liquid may be added with a plasticizer or a photopolymerization initiator. Thereby, the modification of the optically anisotropic layer may be conducted simultaneously by penetration of these additives.

### (Transferring Method of Transferring Material to Target Material of Transfer)

Methods of transferring the transferring material on a target material of transfer are not specifically limited, so far as the optically anisotropic layer can be transferred onto the target material of transfer such as a support. For example, the transferring material in a film form may be attached so that the surface of the adhesive layer for transfer is faced to the surface of the target material of transfer, then pressing under heating or no-heating with rollers or flat plates, which are heated and/or pressed by a laminator. Specific examples of the laminator and the method of lamination include those described in JP-A-7-110575, JP-A-11-77942, JP-A-2000-334836 and JP-A-2002-148794, wherein the method described in JP-A-7-110575 is preferable in terms of low contamination.

Examples of the target material of transfer include a support, a laminated structure which is comprised of a support and another functional layer, and a birefringent pattern builder.

### (Steps Included in Transfer)

The temporary support may be separated or not be separated after the transfer of a birefringent pattern builder on the target material of transfer. When the temporary support is not separated, the temporary support preferably has transparency suited for the patterned light exposure afterwards and heat-resistance sufficient for surviving the baking step. A step for removing unwanted layers which has been transferred with the optically anisotropic layer may be included in the method. For example, when polyvinyl alcohol/polyvinylpyrrolidone copolymer is used in the alignment layer, the alignment layer and the layers above can be removed by development with an aqueous weak alkaline developing solution. Methods of the development may be any of known methods such as paddle development, shower development, shower-and-spin development and dipping development. The temperature of the developing solution is preferably 20° C. to 40° C., and pH of the developing solution is preferably 8 to 13.

Other layer may be formed on the surface remained after the separation of the temporary support or the removal of the unwanted layers, according to need. Another transferring material may be transferred on the surface remained after the separation of the temporary support or the removal of the unwanted layers, according to need. The transferring material may be the same or different from the previously transferred transferring material. Further, the slow axis of the optically anisotropic layer in the first transferred transferring material may be in the same or different direction from that of the slow axis of the optically anisotropic layer in the second transferred transferring material. As described above, transferring plural optically anisotropic layers is useful for production of a birefringence pattern having large retardation with plural optically anisotropic layers stacked so that the directions of the slow axes are the same, and a specific birefringence pattern with plural optically anisotropic layers stacked so that the directions of the slow axes are different to each other.

### [Production of Birefringent Pattern Member]

By conducting the method including a step of using the birefringent pattern builder to conduct a pattern-like heat treatment or irradiation of ionizing radiation and a step of causing the remaining unreacted reactive group in the optically anisotropic layer to react or deactivate in this order, a patterned birefringent product can be produced. In particular, when the optically anisotropic layer has a retardation disappearance temperature and the retardation disappearance temperature increases by the irradiation of ionizing radiation (or the heat treatment at a temperature equal to or lower than the retardation disappearance temperature), a patterned birefringent product can be produced easily.

The process of forming the birefringent pattern by ionizing irradiation or heat treatment is illustrated by an example below.

The pattern-like irradiation of ionizing radiation may be, for example, exposure to light (patterned light exposure). The patterned light exposure is conducted to cause an unreacted reactive group in the optically anisotropic layer to react and this causes an exposed region to have an increased retardation disappearance temperature. Thereafter, a step of causing the remaining unreacted reactive group in the optically anisotropic layer to react or deactivate is conducted at a temperature higher than the retardation disappearance temperature of the not-exposed region and lower than the retardation disappearance temperature of the exposed region. As a result, only the retardation of the not-exposed region can be selectively caused to disappear to thereby form a birefringent pattern. The step of causing a remaining unreacted reactive group in the optically anisotropic layer to react or deactivate may be an overall exposure or an overall heat treatment (baking) if the reactive group also can be caused to react by heat. For saving cost, the heating at a temperature higher than the retardation disappearance temperature of the not-exposed region and lower than the retardation disappearance temperature of the exposed region also can preferably provide a heat treatment for reaction.

The pattern-like heat treatment also may be conducted by another method as described below. In this method, a region is firstly heated at a temperature close to the retardation disappearance temperature to reduce or disappear the retardation. Thereafter, the step of causing a remaining unreacted reactive group in the optically anisotropic layer to react or deactivate (overall exposure or overall heating) at a temperature lower than the retardation disappearance temperature to thereby obtain a birefringent pattern. In this case, a pattern can be obtained in which the retardation of only the firstly-heated region is lost.

The pattern exposure and the pattern-like heat treatment are described in detail later.

### [Timing of Transfer]

When the transfer is conducted in the production of the birefringent pattern of the present invention, the timing of the transfer is arbitrary. Specifically, when the transfer is conducted in the production of a birefringent pattern including, for example, at least the following steps of in this order:

coating and drying a solution containing a liquid crystalline compound;

causing one kind of the reactive groups to react by applying heat or irradiating ionizing radiation;

conducting heat treatment or irradiation of ionizing radiation again to react reactive groups including reactive groups different from the one reacted in the above step; and

causing an unreacted reactive group remaining in the optically anisotropic layer to react or deactivate (e.g., baking at a temperature of 50° C. or more and 400° C. or less), the transfer may be conducted immediately after the step of coating and drying a solution containing a liquid crystalline compound, after the step of causing one kind of the reactive groups to react by applying heat or irradiating ionizing radiation, or immediately before or after the step of causing the remaining unreacted reactive group to react or deactivate.

In this case, depending on the timing of the transfer, a material to be used may be limited. When the transfer is conducted immediately after the coating and drying for example, the material must be made of a liquid crystalline compound that can endure the transfer while being in an unreacted status. When the baking is conducted as the step of causing the remaining unreacted reactive group to react or deactivate and then the transfer is conducted for example, a material to be used as a temporary support until the transfer must be a material that can endure the baking. From the viewpoint of enabling the use of materials in a wide range, the transfer is preferably conducted after the step of causing one kind of the reactive groups to react by applying heat or irradiating ionizing radiation.

### [Timing of Pattern Formation]

In the production of the birefringent pattern of the present invention, the pattern-like heat treatment or irradiation of ionizing radiation may be conducted at any of the step of conducting heat treatment or irradiation of ionizing radiation. Specifically, for example, in the production of the birefringent pattern containing at least the following steps of in this order:

coating and drying a solution containing a liquid crystalline compound;

causing one kind of the reactive groups to react by applying heat or irradiating ionizing radiation; and

conducting heat treatment or irradiation of ionizing radiation again to react reactive groups including reactive groups different from the one reacted in the above step,

the step of causing one kind of the reactive groups to react by applying heat or irradiating ionizing radiation may be conducted in a patterned manner, the step of conducting heat treatment or irradiation of ionizing radiation again to react reactive groups including reactive groups different from the one reacted in the above step may be conducted in a patterned manner, or both of the steps also may be conducted in a patterned manner.

On the other hand, when the transfer is conducted in the production of the birefringent pattern, a material to be used may be limited depending on the timing at which the pattern-like heat treatment or irradiation of ionizing radiation is conducted. When the step of causing one kind of the reactive groups to react by applying heat or irradiating ionizing radiation is conducted in a patterned manner and the transfer is conducted immediately thereafter for example, the material must be made of a liquid crystalline compound that can endure the transfer while an unreacted region exists. From the viewpoint of enabling the use of materials in a wide range, when the transfer is conducted in the middle of the production of the birefringent pattern, a not-pattern-like heat treatment or irradiation of ionizing radiation is preferably conducted prior to the transfer.

On the other hand, when it is desired that the transfer is followed by the formation of a pattern in accordance with the shape of the base material after the transfer or the base, it is preferred that the step of causing one kind of the reactive groups to react by applying heat or irradiating ionizing radiation is firstly conducted in a not-patterned manner (═Overall) and then the transfer is conducted, after which the step of conducting heat treatment or irradiation of ionizing radiation again to react reactive groups including reactive groups different from the one reacted in the above step is conducted in a patterned manner. Such a case will be described below.

Concerning the invention, the term “reaction conditions” refers to conditions for the “pattern exposure” or “pattern-like heat treatment” described below.

First, the production of a birefringent pattern by a pattern-like exposure and an overall heat treatment or an overall exposure at a temperature equal to or higher than the retardation disappearance temperature will be described in detail.

### [Patterned Light Exposure]

The patterned light exposure for producing a birefringent pattern may be conducted so as to form only an exposed region and a not-exposed region so that a region in the birefringent pattern builder in which birefringence properties are desired to be left is exposed. Alternatively, exposures based on different exposure conditions also may be conducted in a patterned manner.

The method of patterned light exposure may be a contact light exposure using a mask, proximity light exposure, projected light exposure, or direct drawing by focusing on the predetermined point by using laser or electron beam without a mask. The irradiation wavelength of the light source for the light exposure preferably has a peak in the range of 250 to 450 nm, and more preferably in the range of 300 to 410 nm. When a photosensitive resin layer is used to form different levels (unevenness) at the same time, it is also preferred that light in a wavelength region at which the resin layer can be cured (e.g., 365 nm, 405 nm) is irradiated to the resin layer. Specific examples of the light source include extra-high voltage mercury lamp, high voltage mercury lamp, metal halide lamp, and blue laser. Energy of exposure generally falls in the range preferably from about 3 mJ/cm² to about 2,000 mJ/cm², more preferably from about 5 mJ/cm² to about 1,000 mJ/cm², and further preferably from about 10 mJ/cm² to about 500 mJ/cm².

Examples of the parameters of the exposure conditions include, but are not particularly limited thereto, exposure peak wavelength, exposure intensity, exposure time period, exposure quantity, exposure temperature, exposure atmosphere, and the like. Among them, exposure peak wavelength, exposure intensity, exposure time period, and exposure quantity are preferable, and exposure intensity, exposure time period, and exposure quantity are more preferable, from the viewpoints of convenience in adjusting the conditions. The pattern exposure may be performed by a plurality of exposures, or by single exposure by using, for example, a mask having two or more regions having transmission spectra different from each other, or alternatively by exposure in combination thereof. The expression that the light exposure having different exposure conditions are conducted in a patterned manner means that the light exposure is conducted so that two or more exposure regions exposed under different exposure conditions are generated.

Regions exposed under different exposure conditions upon pattern exposure have, after baking, different birefringence property, in particular different retardation values, that are controlled by the exposure conditions. It is thus possible to produce birefringence patterns having desired retardation values which are different from each other between the regions after baking, by adjusting the exposure condition at the respective region upon pattern exposure. The exposure condition for the two or more exposure regions exposed under different exposure conditions may be changed discontinuously or continuously.

### (Mask Exposure)

Exposure by using an exposure mask is useful as a means for forming exposure regions different in exposure conditions. For example, it is possible to change readily the exposure conditions between the region subjected to the first time exposure and the region subjected to the second time exposure, by exposing first only one region by using an exposure mask, and then exposing second the other region or the entire surface by using another mask, while the temperature, atmosphere, exposure intensity, exposure time period, or exposure wavelength is changed from that in the first time exposure. A mask having two or more regions respectively showing different transmission spectra is particularly useful as the mask for modifying the exposure intensity or the exposure wavelength. In that case, multiple regions may be exposed to light under conditions different in exposure intensity or exposure wavelength from each other, only by a single exposure operation. It is of course possible to obtain different exposure quantities by subjecting to exposure for the same time period under different exposure intensities.

If scanning exposure, for example, with laser is used, it is possible to change the exposure conditions in the respective regions, for example, by changing the light source intensity or the scanning speed depending on the exposure regions.

Further, the method of the present invention may be combined with the steps, in which another transferring birefringence pattern builder is transferred on the laminated structure obtained by conducting patterned light exposure to a birefringence pattern builder, and then another patterned light exposure is conducted. The retardation values retained after baking can be effectively changed among the region which is a non-light-exposed region both in the first and second exposures (generally having the lowest retardation value), the region which is a light-exposed region in the first exposure but a non-light-exposed region in the second exposure, and the region which is a light-exposed region both in the first and second exposures (generally having the highest retardation value). On the other hand, the region which is unexposed at the first time but is exposed at the second time is considered to be equal, upon the second time, to the region which is exposed at both the first and second times. In a similar manner, four or more regions can be readily formed, by conducting transfer and patterned light exposure alternately three, four or more times. The above-mentioned method is useful when the different regions desirably have a difference (such as a difference in the direction of optical axis or very large difference in retardation) that cannot be provided only by modification of the exposure conditions.

[Reaction Processing by Overall Heat Treatment (Baking) at Temperature Equal to or Lower than Retardation Disappearance Temperature or Overall Exposure]

In order that the birefringent pattern builder subjected to the patterned light exposure is processed so the not-exposed region has a reduced retardation while retaining the retardation of the exposed region and in order to cause the remaining unreacted reactive groups to react or deactivate while this status is being maintained to thereby obtain a stable birefringent pattern, an overall heat treatment or an overall exposure at a temperature equal to or higher than the retardation disappearance temperature of the not-exposed region is preferably conducted.

When the processing is conducted by an overall heat treatment, although temperature conditions change depending on the material, the processing is preferably performed at a temperature equal to or higher than the retardation disappearance temperature of the not-exposed region and equal to or lower than the retardation disappearance temperature of the exposed region. Further, the temperature is also preferably a temperature that efficiently promotes the reaction or deactivation of the unreacted reactive group. Specifically, although not particularly limited, a heat treatment at about 50 to 400° C. is preferred, a heat treatment at about 100 to 260° C. is more preferred, a heat treatment at about 150 to 250° C. is further preferred, and a heat treatment at about 180 to 230° C. is particularly preferred. However, a suitable temperature changes depending on required birefringence properties (retardation) or the thermal curing reactivity of the optically anisotropic layer to be used. The heat treatment also can be expected to provide an effect of evaporating or burning unnecessary components in the material. Although the time of the heat treatment is not particularly limited, the time of 1 minute or more and 5 hours or less is preferred, the time of 3 minutes or more and 3 hours or less is more preferred, and the time of 5 minutes or more and 2 hours or less is particularly preferred.

When a temperature equal to or lower than the retardation disappearance temperature of the exposed region causes an insufficient reactivity of an unreacted reactive group to thereby suppress the reaction processing from progressing sufficiently for example, it is also useful to conduct an overall exposure while maintaining a temperature equal to or higher than the retardation disappearance temperature of the not-exposed region. In this case, a preferred light source is the same as that described in the patterned light exposure. An exposure amount is generally preferably about 3 to 2,000 mJ/cm², more preferably about 5 to 1,000 mJ/cm², further preferably about 10 to 500 mJ/cm², and most preferably about 10 to 300 mJ/cm².

Next, a detailed description is given of the production of the birefringent pattern by pattern-like heat treatment to cause a patterned reduction in retardation and by overall heat treatment at a temperature equal to or lower than the retardation disappearance temperature or overall exposure.

### [Pattern-like Heat Treatment (Writing of Heat Pattern)]

The heating temperature of pattern-like heat treatment is not limited and may be any temperature so long as the temperature causes a heated part and a non-heated part to have different retardations. When a heated part desirably has retardation of substantially 0 nm in particular, it is preferred to conduct the heating at a temperature equal to or higher than the retardation disappearance temperature of the optically anisotropic layer of the birefringent pattern builder used. On the other hand, the heating temperature is preferably lower than a temperature at which the optically anisotropic layer is burned or colored. The heating may be generally performed at a temperature in a range from about 120° C. to about 260° C., more preferably in a range from 150° C. to 250° C., and further preferably in a range from 180° C. to 230° C.

Although the method of heating a part (region) of a birefringent pattern builder is not particularly limited, such methods may be used including a method of causing a heating body to have a contact with a birefringent pattern builder, a method of providing or placing a heating body in the close vicinity of a birefringent pattern builder, and a method of using a heat mode exposure to partially heat a birefringent pattern builder.

[Reaction Processing by Overall Heat Treatment (Baking) at Temperature Equal to or Lower than Retardation Disappearance Temperature or Overall Exposure]

A region that is in an optically anisotropic layer subjected to the pattern-like heat treatment and not subjected to a heat treatment still includes an unreacted reactive group while retaining the retardation, and thus is still in an unstable status. In order to react or deactivate the unreacted reactive group remaining in the not-treated region, a reaction processing by an overall heat treatment or an overall exposure is preferably conducted.

The reaction processing by an overall heat treatment is conducted preferably at a temperature lower than the retardation disappearance temperature of an optically anisotropic layer of the birefringent pattern builder used that efficiently promotes the reaction or deactivation of the unreacted reactive group.

Birefringence pattern can be produced by applying heat to the birefringence pattern builder after patterned light exposure at 50 to 400° C., preferably 80 to 400° C. When the retardation disappearance temperature of the optically anisotropic layer in the birefringence pattern builder used for forming birefringence pattern before the light exposure is referred to as T1 (° C.), and the retardation disappearance temperature after the light exposure as T2 (° C.), (provided that when the retardation disappearance temperature is not in the range of the temperature of 250° C. or lower, T2=250), the temperature of baking is preferably T1° C. or higher and T2° C. or lower, more preferably (T1+10)° C. or higher and (T2-5)° C. or lower, and most preferably (T1+20)° C. or higher and (T2-10)° C. or lower.

Generally, the heating at about 120 to 180° C. may be conducted, 130 to 170° C. is more preferred, and 140 to 160° C. is further preferred. However, a suitable temperature changes depending on required birefringence properties (retardation) or the thermal curing reactivity of an optically anisotropic layer used. The time of the heat treatment is not particularly limited. The time of the heat treatment is preferably 1 minute or more and 5 hours or less, the time of 3 minutes or more and 3 hours or less is more preferred, and the time of 5 minutes or more and 2 hours or less is particularly preferred.

By baking, the retardation in the region unexposed to light in the birefringence pattern builder lowers, whereas the retardation in the region exposed to light, in which retardation disappearance temperature has risen by the previous patterned light exposure, lowers only slightly, absolutely does not lower, or rises. As a result, the retardation in the region unexposed to light is smaller than that in the region exposed to light, enabling production of birefringence pattern (a patterned optically anisotropic layer).

To produce an optical effect, the exposed region after baking preferably has a retardation of 5 nm or more, more preferably 10 nm or more and 5,000 nm or less, most preferably 20 nm or more and 2,000 nm or less. If the retardation is 5 nm or less, it may be difficult to visually identify the prepared birefringent pattern.

To produce an optical effect, the unexposed region in the birefringent pattern builder after baking also preferably has a retardation of 80% or less, more preferably 60% or less, even more preferably 20% or less of that before baking, most preferably less than 5 nm. In particular, a retardation of less than 5 nm after baking gives the impression as if there was visually completely no birefringent pattern in the region. This makes it possible to present black under crossed nicols and present colorlessness on a combination of a polarizing plate and a reflective plate under parallel nicols. Therefore, the birefringent pattern builder capable of forming an unexposed region with a retardation of less than 5 nm after baking is useful when the birefringent pattern is used to present a color image or when a laminate of layers of different patterns is used.

The reaction processing also can be conduced by an overall exposure instead of the overall heat treatment. In this case, the irradiation wavelength of a light source preferably has a peak in a range from 250 to 450 nm and more preferably in a range from 300 to 410 nm. When the photo-sensitive resin layer is used to form different levels at the same time, irradiation of light having a wavelength region at which the resin layer can be cured (e.g., 365 nm, 405 nm) is also preferred. Specific examples of the light source include extra-high-pressure mercury lamp, high-pressure mercury lamp, metal halide lamp, and blue laser. Exposure amount generally falls in the range preferably from about 3 mJ/cm² to about 2,000 mJ/cm², more preferably from about 5 mJ/cm² to about 1,000 mJ/cm², further preferably from about 10 mJ/cm² to about 500 mJ/cm², and most preferably from about 10 mJ/cm² to about 300 mJ/cm².

Alternatively, another transferring material for producing birefringence pattern builder may be transferred on the birefringence pattern builder which has been baked, and then a patterned light exposure and baking may be conducted thereon. In this case, the retardation values after the second baking can be effectively changed between the region which is region unexposed to light both in the first and second exposure, the region which is region exposed to light in the first exposure and region unexposed to light in the second exposure, the region which is a region unexposed to light in the first exposure and region exposed to light in the second exposure (the retardation of the region unexposed to light in the first exposure already disappears due to the baking), and the region which is region exposed to light both in the first and second exposure. This method is useful when two regions having birefringence property of different slow-axis directions to each other are needed to be formed without overlap to each other.

### [Finishing Heat Treatment]

When the birefringent pattern produced by the steps according to the preceding sections is desired to have a further-improved stability, a finishing heat treatment also may be performed for the purpose of further reacting unreacted reactive groups still remaining after the fixing to increase the durability, and for the purpose of evaporating or burning an unnecessary component in the material to remove such a component. In particular, the finishing heat treatment is effective when a birefringent pattern is produced by a patterned light exposure and a overall heating or by a pattern-like heat treatment and an overall exposure. The finishing heat treatment may be performed at a temperature from about 180 to about 300° C., more preferably from 190 to 260° C., and further preferably from 200 to 240° C. The time of the heat treatment is not particularly limited. However, the time of the heat treatment is preferably 1 minute or more and 5 hours or less, more preferably 3 minutes or more and 3 hours or less, and particularly preferably 5 minutes or more and 2 hours or less.

### [Products Using the Birefringent Pattern Member]

The packaging material of the invention obtained by subjecting the birefringent pattern builder to exposure and baking as described above is almost colorless and transparent under normal conditions. When it is placed between two polarizing plates or between a reflective layer and a polarizing plate, however, it shows distinctive light and dark patterns or desired colors caused by interference from the controlled retardation, which is easy to visually recognize. Using this property, the packaging material obtained by the above method can be used as, for example, means for preventing forgery. That is, the packaging material is normally almost invisible with the naked eye, whereas, through a polarizing plate, the patterned birefringent product can exhibit multi-colored image which can be readily identified. A copy of the birefringence pattern without any polarizing plate exhibits no image, whereas a copy through a polarizing plate exhibits a permanent pattern which is visible with the naked eye without any polarizing plate. Therefore, the reproduction of the birefringence pattern is difficult. Such kind of method of producing birefringence pattern is not widely spread, and needs unusual or special kind of material. Therefore, the patterned birefringent product can be considered to be favorably adapted as means of preventing forgery.

Besides the forgery preventing means, applications may include information or image display media utilizing a latent image capable of showing minuteness and/or multicolor.

Although the packaging material of the invention has authentic product identifying means, the fact that it has the authentic product identifying means is less likely to be found, because the authentic product identifying means is invisible. Since the manufacturing method and materials are unique and the copy is difficult, the authentic product identifying (forgery preventing) means is also suitable. Since the packaging material is uniform and the authentic product identifying means such as an image is invisible without a polarizing plate, problems such as degradation in design quality due to the existence of the authentic product identifying means do not occur. In addition, since the packaging material itself has the authentic product identifying means when produced, the packaging material is easy to handle and can be easily adapted to a variety of commercial products different in shape or size. A sophisticated multicolor latent image can also be formed in the packaging material of the invention. Therefore, the packaging material of the invention not only provides excellent forgery preventing means, but also may be applicable to other means such as information or image display media.

### EXAMPLES

The present invention will be described in more detail based on the following examples. Any materials, reagents, amount and ratio of use and operations, as shown in the examples, may appropriately be modified without departing from the spirit and scope of the present invention. It is therefore understood that the present invention is by no means intended to be limited to the specific examples below.

### [Production of Birefringent Pattern Builder]

### (Preparation of Coating Liquid CU-1 for Dynamic Property Control Layer)

The composition below was prepared, filtered through a polypropylene filter having a pore size of 30 μm, and the filtrate was used as a coating liquid CU-1 for forming a dynamic property control layer.

Composition of Coating Liquid for Dynamic
Property Control Layer (mass %)

| | |
|---|---|
| Copolymer of methyl methacrylate, 2-ethylhexyl acrylate, benzyl | 5.89 |
| methacrylate and methacrylic acid, having a copolymerization | |
| composition ratio (molar ratio) of 55/30/10/5, a weight-average | |
| molecular mass of 100,000, and a Tg of about 70° C. | |
| Copolymer of styrene and acrylic acid having a copolymerization | 13.74 |
| composition ratio (molar ratio) of 65/35, a weight-average | |
| molecular mass of 10,000, and a Tg of about 100° C. | |
| BPE-500 (trade name, manufactured by | 9.20 |
| Shin-Nakamura Chemical Co., Ltd. | |
| Megafac F-780-F (trade name, manufactured by Dainippon Ink | 0.55 |
| & Chemicals Incorporation) | |
| Methanol | 11.22 |
| Propylene glycol monomethyl ether acetate | 6.43 |
| Methyl ethyl ketone | 52.97 |

(Preparation of Coating Liquid al-1 for Alignment Layer)

The composition below was prepared, filtered through a polypropylene filter having a pore size of 30 μm, and the filtrate was used as a coating liquid AL-1 for forming an alignment layer.

Composition of Coating Liquid for Alignment layer (mass %)

| | |
|---|---|
| Polyvinyl alcohol (trade name: PVA205, manufactured | 3.21 |
| by Kuraray Co., Ltd.) | |
| Polyvinylpyrrolidone (trade name: Luvitec K30, manufactured | 1.48 |
| by BASF) | |
| Distilled water | 52.10 |
| Methanol | 43.21 |

### (Preparation of Coating Liquid LC-1 for Optically Anisotropic Layer)

The composition below was prepared, filtered through a polypropylene filter having a pore size of 0.2 μm, and the filtrate was used as coating liquid LC-1 for forming an optically anisotropic layer.

LC-1-1 is a liquid crystalline compound having two reactive groups, one of which is acrylic group, i.e. a radically reactive group, and the other of which is oxetanyl group, i.e. a cationically reactive group.

LC-1-2 is a disk-shaped compound added for the purpose of orientation control. LC-1-2 was synthesized according to the method described in Tetrahedron Lett., Vol. 43, p. 6793 (2002).

Composition of Coating Liquid for Optically Anisotropic Layer (%)

| | |
|---|---|
| Rod-like liquid crystalline (LC-1-1) | 32.59 |
| Horizontal orientation agent (LC-1-2) | 0.02 |
| Cationic photopolymerization initiator (trade name: CPI100-P, manufactured by SAN-APRO Co., Ltd.) | 0.66 |
| Polymerization control agent (trade name: IRGANOX 1076, manufactured by Chiba Speciality Chemicals Co., | 0.07 |
| Ltd.) | |
| Methyl ethyl ketone | 66.66 |

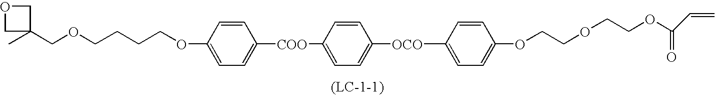

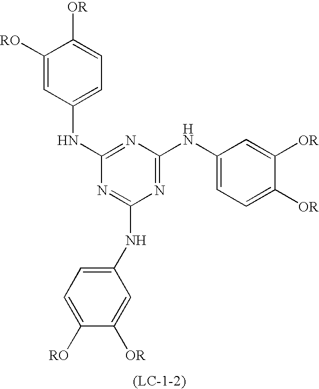

R = CH₂CH₂OCH₂CH₂C₆F₁₃

### (Preparation of Coating Liquid AD-1 for Adhesive Layer for Transfer)

The composition below was prepared, filtered through a polypropylene filter having a pore size of 0.2 μm, and the filtrate was used as coating liquid AD-1 for forming an adhesive layer for transfer.

Composition of Coating Liquid for Adhesive Layer for Transfer (mass %)

| | |
|---|---|
| Copolymer of benzyl methacrylate, methacrylic acid, and methyl | 8.05 |
| methacrylate, having a copolymerization composition ratio | |
| (molar ratio) of 35.9/22.4/41.7, and a weight-average molecular | |
| mass of 38,000 | |
| KAYARAD DPHA (trade name, manufactured by | 4.83 |
| Nippon Kayaku) | |
| Radical polymerization initiator (2-trichloromethyl-5-(p- | 0.12 |
| styrylstyryl)1,3,4-oxadiazole | |
| Hydroquinone monomethyl ether | 0.002 |
| Megafac F-176PF (trade name, manufactured by Dainippon Ink | 0.05 |
| & Chemicals Incorporation) | |
| Propylene glycol monomethyl ether acetate | 34.80 |
| Methyl ethyl ketone | 50.538 |
| Methanol | 1.61 |

### (Preparation of Optically Anisotropic Layer-Coated Sample TRC-1 and Transferring

Material TR-1 for Producing Birefringent Pattern)

To the surface of a temporary support formed of a 100-μm-thick polyethylene terephthalate film, the coating liquid for a dynamic property control layer, CU-1, and the coating liquid for an alignment layer, AL-1, in this order were applied by using a wire bar coater and dried. The obtained layers had dry film thickness of 14.6 μm and 1.6 μm, respectively Finally, the coating liquid AD-1 for adhesive layer for transfer was applied to the optically anisotropic layer-coated sample TRC-1 and dried to form a 1.2 μm thick adhesive layer for transfer, so that a transferring material TR-1 for producing a birefringent pattern was obtained.

### (Preparation of Birefringent Pattern BP-1)

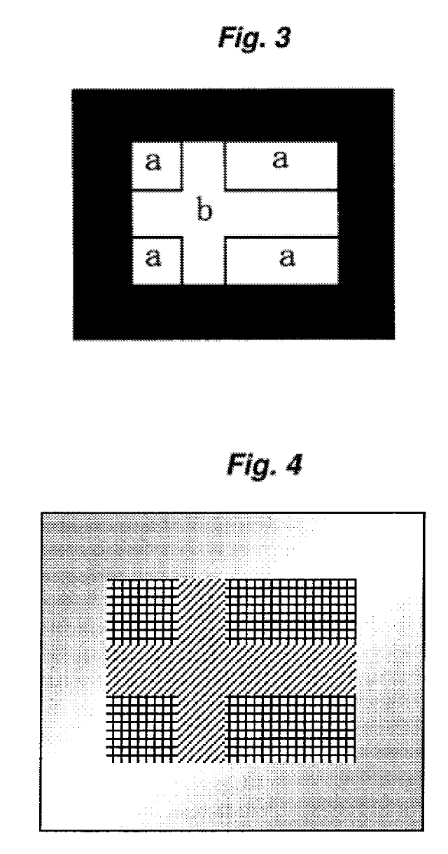

The transferring material TR-1 for producing a birefringent pattern was subjected to pattern exposure at 50 mJ/cm² using M-3L Mask Aligner and Photomask V (each trade name, manufactured by MIKASA CO, LTD) (see FIG. 3, in which white and black regions correspond to exposed and unexposed regions, respectively, the exposed region a has an ultraviolet light (λ=365 nm) transmittance of 17%, and the exposed region b has an ultraviolet light (λ=365 nm) transmittance of 44%). Baking was then performed in a clean oven at 230° C. for 1 hour, so that a birefringent pattern BP-1 was obtained.

### (Preparation of Birefringent Pattern Packaging Material BPW-1 for Making Products to be Authenticated by Transmission Measurement)

A stretched polypropylene resin film with an in-plane retardation of 166 nm was provided as a support for receiving the transfer material. The stretched film heated at 100° C. for 2 minutes and the birefringent pattern BP-1 were laminated using a laminator (Lamic II model, manufactured by Hitachi Industries Co., Ltd.) at a rubber roller temperature of 130° C., a linear pressure of 100 N/cm, and a feeding speed of 1.4 m/minute. After the lamination, the temporary support was separated so that a birefringent pattern packaging material BPW-1 (10 μm in thickness) was obtained.

BPW-1 was placed between two polarizing plates (crossed nicols) and observed. FIG. 4 is an enlarged view showing the observed pattern. In the drawing, the polypropylene resin as the base of the packaging material has a gray color, while the grid region and the slanted line region have a light yellow color and a yellow color, respectively, so that a multicolor pattern is observed.

An aluminum plate having a glossy surface was wrapped with BPW-1 and then observed through a polarizing plate placed above the birefringent pattern. FIG. 4 also shows the observed pattern in which the aluminum plate as the base had a dark blue color which was observed through the packaging material, while the grid region and the slanted line region had a blue color and a yellow color, respectively, so that a multicolor pattern was observed.

### (Preparation of Birefringent Pattern Builder BPW-2 for Making Products to be Authenticated by Reflection Measurement)

Aluminum was vapor-deposited on the back surface of the birefringent pattern packaging material BPW-1 (opposite to the patterned surface) to form a reflective layer.

BPW-2 was observed through a polarizing plate placed above it. FIG. 4 shows the observed pattern, in which the aluminum foil as the base had a dark blue color, while the grid region and the slanted line region had a blue color and a yellow color, respectively, so that a multicolor pattern was observed.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2008-334406 filed in Japan on Dec. 26, 2008, which is entirely herein incorporated by reference.

What we claim is:

1. A packaging material, comprising at least one optically anisotropic layer which is made from substantially the same layer-forming composition and includes two or more regions different in birefringence property.

2. The packaging material according to claim 1, wherein the optically anisotropic layer is formed by using a liquid crystalline compound having a reactive group.

3. The packaging material according to claim 2, wherein the liquid crystalline compound in the optically anisotropic layer is oriented in a substantially constant direction.

4. The packaging material according to claim 1, wherein a substrate having the optically anisotropic layer has a retardation of 2,000 nm or less.

5. The packaging material according to claim 1, wherein it is transparent.

6. The packaging material according to claim 1, comprising a reflective layer.

7. The packaging material according to claim 1, wherein a latent image is visible through a polarizing plate.

8. A method for producing the packaging material according to claim 1, comprising: forming a layer of a composition containing a liquid crystalline compound having a reactive group; applying different reaction conditions to a plurality of regions in the layer; and then performing heating to make the unreacted region optically isotropic and to deactivate the reactive group.

9. A packaging method, comprising wrapping an object having a reflective surface with the packaging material according to claim 1.

10. A method of packaging an object in the packaging material according to claim 1.
